(19) United States
(12) Patent Application Publication
(10) Pub. No.: US 2005/0164903 A1
(43) Pub. Date: Jul. 28, 2005

(54) Complexed surfactant system

(76) Inventors: Ki-Hwan Ko, Daejeon-city (KR); Tae-Sung Kim, Daejeon-city (KR); Yeo-Kyeong Yoon, Daejeon-city (KR)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/485,584

(22) PCT Filed: Aug. 2, 2002
(86) PCT No.: PCT/KR02/01470

(30) Foreign Application Priority Data
Aug. 3, 2001 (KR) 2001-47069
Aug. 3, 2001 (KR) 2001-47070
Aug. 23, 2001 (KR) 2001-51174
Aug. 2, 2002 (KR) 2002-45902

(51) Int. Cl. C11D 1/00

(52) U.S. Cl. 510/504

(57) ABSTRACT

The present invention relates to a mixed surfactant system, and particularly to a mixed surfactant system which comprises an anionic surfactant and a compound comprising at least one kind of non-ionic group or cationic group, and which thus increases cleaning power of the anionic surfactant, increases stability to hard water, lowers surface tension and cmc, and can control initial foamability and foam stability by the mixing ratio of the non-ionic surfactant and the cationic surfactant that can be added together, and that is therefore very useful for a detergent of solid, liquid, gel, or paste types.

### BACKGROUND OF THE INVENTION

(a) Field of the Invention

The present invention relates to a mixed surfactant system showing superior properties by controlling interfacial properties such as cleaning power, foaming property, stability to hard water, surface tension, etc.

(b) Description of the Related Art

It is known that all surfactants including anionic, cationic, non-ionic, and amphoteric surfactants exist as single molecules below a critical micelle concentration (hereinafter referred to as ‘cmc’), and they form micelles when reaching a cmc to show unique surface active properties according to each compound.

However, since surface active properties shown by one kind of surfactant cannot be superior in every respect, studies for overcoming this are under progress. First, studies on mixing surfactants having the same ionicity were undertaken, and then many studies on mixing ionic surfactants and non-ionic surfactants were done. However, few studies for mixing surfactants with different ionicities have been performed thus far, because it has been known that compounds are neutralized when surfactants with different ionicities are mixed and they do not dissolve in water and therefore they form precipitates.

Generally, if anionic and cationic surfactants are simultaneously dissolved in an aqueous solution, they can exist in three forms. First, an anionic surfactant and a cationic surfactant independently exist as free single bodies; second, an anionic surfactant and a cationic surfactant form a complex to become a precipitate; and third, an anionic surfactant and a cationic surfactant form a mixed micelle and are dissolved in the aqueous solution. The complex formed by binding of the anionic and cationic surfactants is called a pseudo-nonionic complex surfactant, and it is known that such a neutral complex can have its solubility increased in water as it has more hydrophilic groups than does a nonionic surfactant. Therefore, these three forms of surfactants are largely influenced by the structure and concentration of the anionic and cationic surfactants. It is known that in order to prevent precipitation, which may occur in the case of an anionic surfactant and a cationic surfactant being mixed to form a mixed surfactant system, and to improve phase stability and physical properties, non-ionic surfactants are mixed. Particularly, it has been reported that in the case of non-ionic surfactants in which an amine oxide, an ethylene oxide, or a propylene oxide as a hydrophilic group are added, superior effects in terms of various surface active effects (for example solubility, cleaning power, emulsifying power, dispersing power, lowering surface tension power, low cmc, etc.) can be obtained, and phase stability of the mixed surfactant can be improved (Surfactant science series vol. 46, mixed surfactant systems).

Recently, patents with the object of improving effects of products by mixing an anionic surfactant, a cationic surfactant, and a non-ionic surfactant in a specific ratio have been published.

U.S. Pat. No. 5,798,329 disclosed a method for prescribing a detergent showing superior effects in concentrated or common form. The superior effects mean superior foaming property, and satisfactory cleaning power and antibacterial power. According to this method, approximately 1˜40 wt % of one or more kinds of anionic surfactants selected from alkylethercarboxylates or alkylethersulfates; approximately 3˜50 wt % of one or more kinds of non-ionic surfactants selected from alcohol alkoxylates, alkylphenol ethoxylates, alkylpolyglycosides, amine oxides, and alkanolamides; and approximately 1˜25 wt % of cationic surfactants selected from one or more kinds of compounds with quaternary ammonium compounds were used in order to improve cleaning power. The cationic surfactant used in this method was a generally-used quaternary ammonium compound, and the non-ionic surfactant was a presently marketed common surfactant.

U.S. Pat. No. 4,576,729 disclosed a method for preparing a liquid detergent with superior phase stability by mixing non-ionic, anionic, and cationic surfactants in a ratio of 2:4:1˜3.5:5:1.

U.S. Pat. No. 5,230,823 described a method for mixing anionic and non-ionic surfactants for a gel type dishwashing detergent, and according to this method, a quaternary ammonium surfactant of a specific type is included in the composition as a foam enhancer.

However, although these methods asserted that cleaning power is superior, they do not mention other physical properties such as stability to hard water, foaming property, surface tension, etc. Also, the non-ionic surfactants used in the above methods are not compounds prepared in order to improve specific effects, but rather methods combining commonly used compounds to obtain a functional mixing ratio.

In addition, Korean Patent Laid Open-Publication No. 2000-10944 disclosed a detergent composition for washing, comprising a dimethyl hydroxyethyl quaternary ammonium surfactant comprising C12˜C14 alkyl groups combined with a polyamine filth-dispersing agent in order to increase fabric washing power. However, the quaternary ammonium surfactant used in this method fixes the length of the alkyl groups as C12˜C14, and this method describes the function of cationic surfactants for improving effects of the polyamine to simply improve filth-removing power when washing synthetic fabrics (for example, polyester) and a detergent composition comprising the same.

In addition, U.S. Pat. No. 6,022,844 clarified that a cationic surfactant was added to a conventional detergent prescription to improve oil-removing power and to simultaneously maintain a scent for a long time and prevent color bleeding. However, this method only describes mixing about 0.1˜3% of the cationic surfactant, and it did not apply a novel compound for controlling physical properties.

### SUMMARY OF THE INVENTION

The present invention is made in consideration of the problems of the prior art, and it is an object of the present invention to provide a compound with a novel structure that can improve physical properties of an anionic surfactant or mixed system of anionic and cationic surfactants.

It is another object of the present invention to provide a mixed surfactant system using the compound to show superior effects compared to using an anionic surfactant alone.

It is another object of the present invention to provide a surfactant system with superior surface active properties such as cleaning power, initial foaming property, stability to hard water, surface tension, cmc, moisturizing power, foam stability, etc.

It is another object of the present invention to provide a detergent composition of a solid, liquid, gel, or paste types comprising the surfactant system, to show effects superior to those of the conventional products.

In order to achieve these objects, the present invention provides a surfactant system comprising
a) an anionic surfactant;
b) a cationic compound represented by the following Chemical Formula 1; and
c) a non-ionic surfactant: 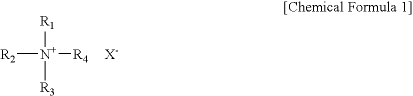
wherein
R₁, R₂, R₃, and R₄ are independently or simultaneously C1˜C20 saturated or unsaturated chain groups, benzyl groups, hydroxylethyl groups, or hydroxy ethyl groups to which 1 to 20 ethylene oxide groups or propylene oxide groups are attached; and
X is halogen atom, a sulfate group, or an acetate group.

The present invention also provides a surfactant system comprising
a) an anionic surfactant; and
b) a cationic compound represented by the following Chemical Formula 2: 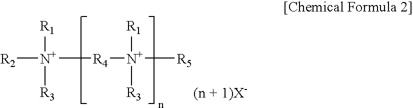
wherein
R₁, R₂, R₃, and R₅ are independently or simultaneously C1˜C20 saturated or unsaturated chain groups, benzyl groups, hydroxylethyl groups, or hydroxylethyl groups to which 1 to 20 ethylene oxide groups or propylene oxide groups are attached; R₄ is a C1˜C20 alkyl group, an alkyl group to which 1˜10 ethylene oxide groups or propylene oxide groups are attached, or an alkyl group to which 1 or more hydroxyl groups are bound; n is an integer of 1 to 20; and X is halogen atom, a sulfate group, or an acetate group.

The present invention also provides a surfactant system comprising
a) an anionic surfactant; and
b) a compound represented by the following Chemical Formula 4: 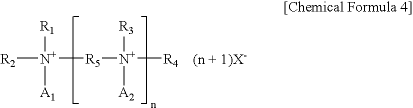
wherein
R₁, R₂, R₃, and R₄ are independently or simultaneously C1˜20 saturated or unsaturated chain groups, benzyl groups, hydroxy ethyl groups, or hydroxy ethyl groups to which 1˜20 ethylene oxide groups or propylene oxide groups are attached; R₅ is a C1˜20 alkyl group, an alkyl group to which 1˜20 ethylene oxide or propylene oxide groups are attached, an alkyl group to which 1 or more hydroxyl groups are bound, an alkyl group comprising at least one double bond, or an alkyl group comprising at least one ether group; A₁ and A₂ are independently or simultaneously C1˜20 saturated or unsaturated chain groups, benzyl groups, hydroxy ethyl groups, hydroxylethyl groups to which 1˜20 ethylene oxide or propylene oxide groups are attached, or oxygen anions (O—); n is an integer of 0 to 20; and X is a halogen atom, a sulfate group, a methylsulfate group, or an acetate group.

The present invention also provides a surfactant system comprising;
a) an anionic surfactant;
b) a compound represented by the above Chemical Formula 4; and
c) a non-ionic surfactant, a cationic surfactant, or a mixture thereof.

The present invention also provides a detergent composition of a solid, liquid, gel, or paste types comprising the above surfactant systems.

### DETAILED DESCRIPTION AND THE PREFERRED EMBODIMENTS

The present invention will now be explained in detail.

The present inventors, in order to solve the problems of the prior art and show superior surface active properties in every respect (for example, cleaning power, foaming property, stability to hard water, surface tension, cmc, moisturizing power, foam stability, etc.), have bound a plurality of hydrophilic groups to a neutral complex produced in an appropriate concentration so as to not form a precipitate to increase solubility to water, thereby preventing precipitation, and consequently developed a compound represented by the above Chemical Formula 1, 2, or 4 that can control physical properties of an anionic surfactant.

Accordingly, the present invention provides a surfactant system comprising a compound represented by the above Chemical Formula 1, 2, or 4 in a specific ratio so as to increase physical properties of the conventional anionic surfactant and thus show superior effects.

According to the present invention, the compound of the above Chemical Formula 1, 2, or 4 is used to control desired physical properties, and even if a small amount thereof is mixed, superior effects can be obtained. Also, the present invention, in order to further improve filth-removing power, prepares a cationic compound of Chemical Formula 4 of a Gemini structure to apply it as an additive, thereby improving or controlling desired physical properties.

Structures similar to that of the cationic compound used in the present invention have been announced by R. Zana (Journal of Colloid and Interface Science, 1998, 199, 169) and R. Rosen (Journal of Colloid and Interface Science, 1996, 179, 261; Journal of Colloid and Interface Science, 1996, 179, 454). However, compounds announced in the aforementioned literature were synthesized as novel cationic surfactants and unique physical properties thereof were measured, and studies regarding a surfactant system mixing anionic surfactants to show superior surface active effects, the object of the present invention, have not been previously undertaken. Moreover, since the compounds announced in the above literature have small hydrophilic groups in molecules, they are very likely to become precipitates when mixed with an anionic surfactant as in the present invention.

The present invention, in order to solve the problems of the compounds announced in the above literature, uses a compound of Chemical Formula 1 wherein a hydroxyl group is introduced in a molecule, or a compound of Chemical Formula 2 wherein one or more kinds of cationic groups and a hydroxyl group are introduced in a molecule, to improve solubility of the produced neutral complex thereby showing superior surface active properties.

In addition, the present invention uses a compound of Chemical Formula 1 wherein one or more kinds of cationic groups or an amine oxide group and a hydrophilic group, i.e., a hydroxyl group, ethylene oxide (EO), or propylene oxide (PO), are introduced in a molecule to improve solubility of the produced neutral complex, thereby showing superior surface active effects.

Specifically, according to the present invention, the compound represented by the above Chemical Formula 1, 2, or 4 increases cleaning power of an anionic surfactant alone, or an anionic surfactant and a non-ionic surfactant, a cationic surfactant, or a mixture thereof, and decreases foam stability while maintaining initial foam, and improves stability to hard water and lowers surface tension and cmc.

The surfactant system of the present invention will now be explained in more detail.

The surfactant system of the present invention comprises an anionic surfactant, a cationic compound of the above Chemical Formula 1, and a non-ionic surfactant, in a specific ratio.

In the surfactant system of the present invention, the mixing ratio of the anionic surfactant, the cationic compound of Chemical Formula 1, and the non-ionic surfactant is preferably 1:0.001:0.001˜1:1:1. If the mole ratio of the anionic surfactant and the cationic compound of Chemical Formula 1 is less than 1:0.001, little change in physical properties of a mixed surfactant system accompanied by mixing the cationic compound appears, and if it exceeds 1:1, it is uneconomical.

In the surfactant system of the present invention, the cationic compound of Chemical Formula 1 is quaternary ammonium compound comprising at least one kind of hydrophilic group in its structure. The cationic compound represented by Chemical Formula 1 of the above structure increases solubility of a neutral compound produced when binding with the anionic surfactant in water to show superior effects.

The cationic compound of Chemical Formula 1 can be prepared by heat-reacting a tertiary amine of a structure corresponding to the object of the present invention with an alkyl halide under basic conditions to cause quaternarization.

The cationic compound of Chemical Formula 1 thus obtained can be prepared as a mono-type compound comprising one kind of quaternary ammonium group as a representative cationic group, or into a compound wherein an ethylene oxide (EO) group is added to a hydroxyl group of the mono-type compound as a non-ionic hydrophilic group.

In addition, the surfactant system of the present invention comprises an anionic surfactant and a cationic compound of Chemical Formula 2 in a specific ratio.

In this surfactant system of the present invention, the mixing ratio of the anionic surfactant and the cationic compound of Chemical Formula 2 is preferably 1:0.0001˜1:0.5. If the mole ratio of the anionic surfactant and the cationic compound of the above Chemical Formula 2 is less than 1:0.0001, little change in physical properties of a mixed surfactant system accompanied by mixing the cationic compound appears, and if it exceeds 1:0.5, it is uneconomical.

In the surfactant system of the present invention, the cationic compound of Chemical Formula 2 is in the form of quaternary ammonium comprising at least one kind of cationic group and hydrophilic group in its structure. The cationic compound of Chemical Formula 2 of the above structure can increase solubility of a neutral compound produced when binding with an anionic surfactant in water to show superior effects.

In the present invention, the cationic compound of Chemical Formula 2, which is mixed with the anionic surfactant in order to show more superior effects, can be prepared by the following two methods.

First, the cationic compound of Chemical Formula 1 can be prepared by i) reacting a secondary amine with a linker represented by the following Chemical Formula 3 under alkaline conditions to prepare a tertiary amine; and ii) reacting the tertiary amine with various kinds of alkyl halides to cause quaternarization.

Second, the cationic compound of Chemical Formula 1 can be prepared by i) reacting a secondary amine with various kinds of alkyl halides under alkaline conditions to prepare a tertiary amine; and ii) binding a linker represented by Chemical Formula 3 to the tertiary amine obtained in step i) to cause quaternarization.
X—(CHₙ)n-X [Chemical Formula 3]
wherein n is an integer of 1 to 20, and X is a halogen atom, a sulfate group, or an acetate group.

The secondary amine corresponding to the object of the present invention is heated with various kinds of alkyl groups under alkaline conditions to prepare a tertiary amine, and then it is reacted with a compound of Chemical Formula 3 functioning as a linker to cause quaternarization, one example of which is as shown in the following Equation 1. 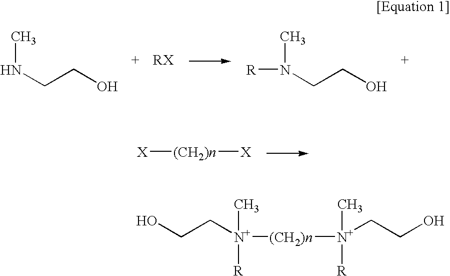
wherein R is a C1˜20 saturated or unsaturated chain group, a benzyl group, a hydroxy ethyl group, or 1 to 20 hydroxy ethyl groups to which ethylene oxide or propylene oxide groups are attached; n is an integer of 1 to 20; and X is a halogen atom, a sulfate group, or an acetate group.

Alternatively, a secondary amine corresponding to the object of the present invention is reacted with a compound of Chemical Formula 3 to synthesize a tertiary amine under alkaline conditions, and then it is reacted with various kinds of alkyl groups to cause quaternarization, one example of which is as shown in the following Equation 2. 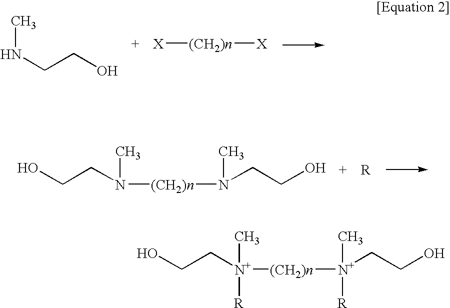
wherein R is a C1˜20 saturated or unsaturated chain group, a benzyl group, a hydroxy ethyl group, or a hydroxy ethyl group to which 1 to 20 ethylene oxide or propylene oxide groups are attached; n is an integer of 1 to 20; and X is a halogen atom, a sulfate group, or an acetate group.

Among the cationic compounds of Chemical Formula 2, bis-forms can be prepared through the reaction pathways of the above Equations 1 or 2.

In addition, the cationic compound comprising 3 or more cationic groups in one molecule can be obtained by reacting an equal number of moles of a secondary amine and epichlorohydrin in an alcohol solvent to synthesize an intermediate, and then polymerizing the intermediate. The polymerization degree of the cationic compound can be controlled by controlling time and temperature of polymerization. The synthesis pathway of the oligomer-type cationic compound is as shown in the following Equation 3.

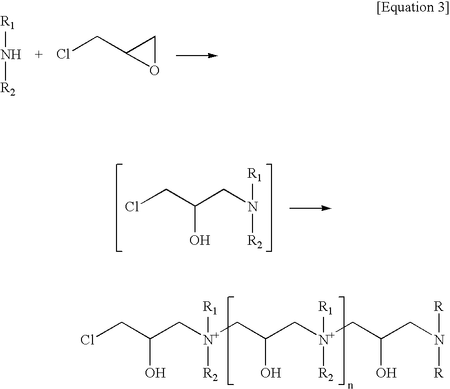

In the present invention, a cationic compound can be easily synthesized by selecting an appropriate method according to a desired compound. The synthesize compound can be confirmed using NMR and MASS analysis.

The cationic compound of Chemical Formula 1 is preferably selected from a group consisting of 1,6-[2(N-dimethylamino)ethanol]hexane, 1,6-[2-(N,N-ethylmethyl amino)ethano]hexane, 1,6-[2-(N,N-butylmethyl amino)ethanol]hexane, 1,6-[2-(N,N-methyloctyl amino)ethanol]hexane, 1,6-[2-(N,N-dodecylmethylamino)ethanol]hexane, 1,8-[2-(N-dimethyl amino)ethanol]octane, 1,8-[2-(N,N-ethylmethyl amino)ethanol]octane, 1,8-[2-(N,N-butylmethyl amino)ethanol]octane, 1,8-[2-(N,N-methyloctylamino)ethanol]octane, 1,8-[2-(N,N-dodecylmethyl amino)ethano]octane, 1,6-[2-(N-dimethylamino)ethanol(EO)₂]hexane, 1,6-[2-(N,N-ethylmethyl amino)ethanol(EO)₂]hexane, 1,6-[2-(N,N-methyloctyl amino)ethanol(EO)₂]hexane, 1,6-[2-(N,N-methyloctyl amino)ethanol(EO)₂]hexane, 1,6-[2-(N,N-dodecylmethyl amino)ethanol(EO)₂]hexane, 1,6-[2-(N-dimethyl amino)ethanol(EO)₄]hexane, 1,6-[2-(N,N-ethylmethyl amino)ethanol(EO)₄]hexane, 1,6-[2-(N,N-butylmethyl amino)ethanol(EO)₄]hexane, 1,6-[2-(N,N-methyloctyl amino)ethanol(EO)₄]hexane, 1,6-[2-(N,N-dodecylmethyl amino)ethanol(EO)₄]hexane, 1,8-[2-(N-dimethyl amino)ethanol(EO)₂]octane, 1,8-[2-(N,N-ethylmethyl amino)ethanol(EO)₂]octane, 1,8-[2-(N,N-butylmethyl amino)ethanol(EO)₄]octane, 1,8-[2-(N,N-methyloctyl amino)ethanol(EO)₄]octane, 1,8-[2-(N,N-dodecylmethyl amino)ethanol(EO)₄]octane, 1,8-[2-(N-dimethyl amino)ethanol(EO)₄]octane, 1,8-[2-(N,N-ethylmethyl amino)ethanol(EO)₄]octane, 1,8-[2-(N,N-butylmethyl amino)Ethanol(EO)₄]octane, 1,8-[2-(N,N-methyloctyl amino)ethanol(EO)₄]octane, 1,8-[2-(N,N-dodecylmethyl amino)ethanol(EO)₄]octane, 1,6-[2-(N-dimethyl amino)ethanol(PO)₂]hexane, 1,6-[2-(N,N-ethylmethyl amino)ethanol(PO)₂]hexane, 1,6-[2-(N,N-methyloctyl amino)ethanol(PO)₂]hexane, 1,6-[2-(N,N-dodecylmethyl amino)ethanol(PO)₂]hexane, 1,6-[2-(N-dimethylamino) Ethanol(PO)₄]hexane, 1,6-[2-(N,N-ethylmethylamino)ethanol(PO)₄]hexane, 1,6-[2-(N,N-butylmethyl amino)ethanol(PO)₄]hexane, 1,6-[2-(N,N-methyloctyl amino)ethanol(PO)₄]hexane, 1,6-[2-(N,N-dodecylmethylamino)Ethanol(PO)₄]hexane, 1,8-[2-(N-dimethylamino)ethanol(PO)₂]octane, 1,8-[2-(N,N-butylmethylamino) Ethanol(PO)₂]octane, 1,8-[2-(N,N-butylmethyl amino)ethanol(PO)₂]octane, 1,8-[2-(N,N-methyloctylamino) Ethanol (PO)₂]octane, 1,8-[2-(N,N-dodecylmethylamino)ethanol(PO)₂]octane, 1,8-[2-(N-dimethylamino)ethanol(PO)₄]octane, 1,8-[2-(N,N-ethylmethylamino)ethanol(PO)₄]octane, 1,8-[2-(N,N-butylmethylamino)ethanol(PO)₄]octane, 1,8-[2-(N,N-methyloctylamino)ethanol(PO)₄]octane, and 1,8-[2-(N,N-dodecylmethylamino)ethanol(PO)₄]octane.

In addition, the surfactant system of the present invention comprises an anionic surfactant and a compound of the above Chemical Formula 4.

The mixing ratio of the anionic surfactant and the compound of Chemical Formula 4 is preferably 1:0.0001˜1:1.0 by mole ratio. If the mole ratio of the anionic surfactant and the compound of Chemical Formula 4 is less than 1:0.0001, little change in physical properties of a mixed surfactant system accompanied by mixing a non-ionic compound appears, and if exceeding 1:1.0, it is uneconomical.

Also, the surfactant system of the present invention may further comprise a non-ionic surfactant, a cationic surfactant, or a mixture thereof in addition to the mixed system of the anionic surfactant and the compound of Chemical Formula 4 to form a mixed surfactant system showing more superior effects.

In the case of a mixed system of an anionic surfactant, a compound of Chemical Formula 4, and a non-ionic surfactant, the mixing ratio thereof is preferably 1:0.0001:0.0001˜1:1.0:0.5 by mole ratio.

Also, in the case of a mixed system of an anionic surfactant, a compound of Chemical Formula 4, and a cationic surfactant, the mixing ratio thereof is preferably 1:0.0001:0.0001˜1:1.0:0.5 by mole ratio.

Also, in the case of a mixed system of an anionic surfactant, a compound of Chemical Formula 4, a non-ionic surfactant, and a cationic surfactant, the mixing ratio thereof. Is preferably 1:0.0001:0.0001:0.0001˜1:1.0:0.5:0.5.

In addition, in the surfactant system of the present invention, the compound of Chemical Formula 4 comprises a cationic group or an anionic group in its molecular structure, and the compound comprises at least one hydrophilic group. The compound of Chemical Formula 4 of the above structure, if binding with an anionic surfactant, increases solubility of the produced mixture in water to show superior effects.

In Chemical Formula 4, when A₁ and A₂ are oxygen anions, a cation of nitrogen and an anion of oxygen charge-offset each other to show characteristics of a nonionic compound. Also, in Chemical Formula 1, when A₁ and A₂ are independently or simultaneously C1˜20 saturated or unsaturated chain groups, benzyl groups, hydroxy ethyl groups, or hydroxy ethyl groups to which 1˜20 ethylene oxide or propylene oxide groups are attached, the compound shows characteristics of an cationic compound.

In the compound of Chemical Formula 4, when an oxygen anion is bound to A₁ and A₂, specifically when the compound is a non-ionic compound comprising an amine oxide group, it can be prepared by the following methods.

First, the non-ionic compound of the above Chemical Formula 4 can be prepared by a) reacting a secondary amine with a linker of the following Chemical Formula 5 under alkaline conditions to prepare a tertiary amine; and b) reacting the obtained tertiary amine with peroxide (H₂O₂). 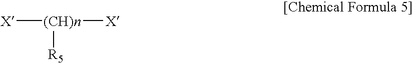
wherein n is an integer of 1 to 20; X is a halogen atom; R₅ is hydrogen, or a C1˜20 alkyl or allyl group comprising at least one double bond, hydroxyl group, or ether group.

A secondary amine corresponding to the object of the present invention and the compound of the above Chemical Formula 4 are reacted to synthesize a tertiary amine under alkaline conditions, and then it is reacted with peroxide to prepare amine oxide, one example of which is as shown in the following Equation 4: 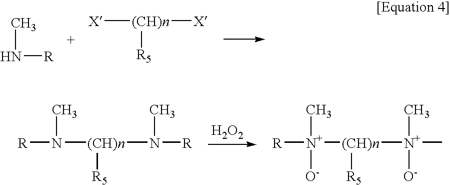
wherein R is a C1˜20 saturated or unsaturated chain group, benzyl group, hydroxy ethyl group, or hydroxy ethyl group to which 1 to 20 ethylene oxide or propylene oxide groups are attached; n is an integer of 1 to 20; X′ is a halogen atom; R₅ is hydrogen, or a C1-20 alkyl or allyl group comprising at least one double bond, hydroxyl group, or ether group.

Among the non-ionic compounds of Chemical Formula 4, bis-forms can be prepared through the pathway of Equation 4.

Also, a compound of Chemical Formula 4 comprising 3 or more amine oxide groups in one molecule can be prepared by the following methods.

It can be prepared by reacting an equal number of moles of a primary amine and epichlorohydrin in an alcohol solvent to synthesize a secondary amine intermediate, and then polymerizing the intermediate to a tertiary amine and reacting it with peroxide. The polymerization degree of the intermediate can be controlled by controlling time and temperature of polymerization when synthesizing the tertiary amine. One example of the synthesis pathway of the non-ionic compound of such oligomer form is as shown in the following Equation 5. 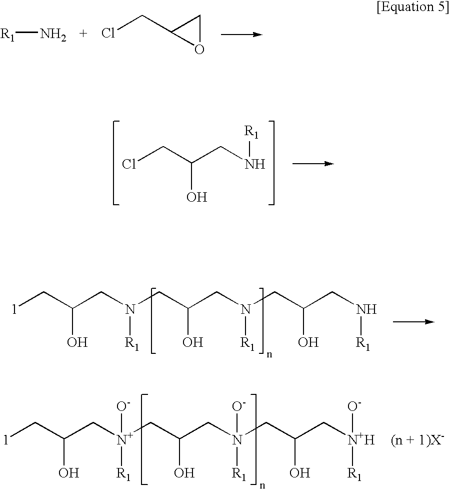
wherein R₁, n, and X are as defined in the above.

The present invention can select an appropriate synthesis method according to a desired compound to easily synthesize a non-ionic compound. The synthesized compound can be confirmed using NMR and MASS analysis.

Among the compound of Chemical Formula 4 prepared by the above method, a non-ionic compound is preferably selected from a group consisting of N,N,N-dimethyllauryl amine oxide; N,N,N-ethylmethyllauryl amine oxide; N,N,N-dimethyldodecyl amine oxide; N,N,N-butylmethyllauryl amine oxide; N,N,N-dimethylhexadecyl amine oxide; N,N,N-dibutyllauryl amine oxide; N,N,N-(2-hydroxyethyllaurylmethyl)amine oxide; N,N,N-(di-2-hydroxyethyllauryl)amine oxide; N,N,N-(2-hydroxyethyllauryl butyl)amine oxide; N,N,N-(2-hydroxy(EO)₅ethyllaurylmethyl)amine oxide; N,N,N-(2-hydroxyethyl(PO)₅laurylmethyl)amine oxide; N,N,N-(2-hydroxyethyl(EO)₅(PO)₅laurylmethyl)amine oxide; N,N,N-(2-hydrxoyethyl(EO)₁₀laurylmethyl)amine oxide; N,N,N-(2-hydrxoyethyl(EO)₁₅laurylmethyl)amine oxide; 1,6-(N,N-butylmethylaminooctyl)hexane; 1,6-(N,N-butylmethylaminooctyl)dipropylether; 1,6-(N,N-butylmethylaminooctyl)-3-hydroxyhexane; 1,6-(N,N-butylmethylaminooctyl)butane; 1,6-(N,N-butylmethylaminooctyl)octane; 1,6-(N,N-butylmethyl amin oxyl)-2-hydroxypropane; 1,6-[2-(N-methylaminooctyl)ethanol]hexane; 1,6-[2-(N-methyl aminooctyl)Ethanol(EO)₅]hexane; 1,6-[2-(N-methyl aminooctyl)ethanol(PO)₅]hexane; 1,6-[2-(N-methyl aminooctyl)ethanol (EO)₅(PO)₅]hexane; 1,6-[2-(N-methyl aminooctyl)ethanol(EO)₅]hexane; 1,6-[2-(N-methyl aminooctyl)ethanol]dipropylether; 1,6-[2-(N-methyl aminooctyl)ethanol]-2-hydroxypropane; 1,6-[2-(N-methylaminooctyl)Ethanol]butane; 1,6-[2-(N-methyl aminooctyl)ethanol]octane; and a mixture thereof.

In addition, in the surfactant system of the present invention, when A₁ and A₂ in a compound of Chemical Formula 4 are independently or simultaneously C1-20 saturated or unsaturated chain groups, benzyl groups, hydroxy ethyl groups, or hydroxy ethyl groups to which 1-20 ethylene oxide or propylene oxide groups are attached, the compound comprises a cationic group.

Among the compounds of Chemical Formula 4, preparation thereof comprising a cationic group is similar to with the above Equations 3 to 5, and the following two methods can be used.

First, the cationic compound of Chemical Formula 4 can be prepared by a) reacting a secondary amine with a compound comprising a C1-20 saturated or unsaturated chain group, a benzyl group, a hydroxy ethyl group, or a hydroxy ethyl group to which 1 to 20 ethylene oxide or propylene oxide groups are attached, under alkaline conditions to prepare a tertiary amine; and b) adding a compound of the following Chemical Formula 5 to the obtained tertiary amine to cause quaternarization.
[Chemical Formula 5] 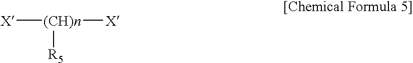
wherein n is an integer of 1 to 20; X′ is a halogen atom; R₅ is hydrogen, or a C1-20 alkyl or alkyl group comprising at least one double bond, hydroxyl group, or ether group.

Alternatively, the cationic compound of Chemical Formula 4 can be prepared by a) reacting a secondary amine with a compound of Chemical Formula 5 under alkaline conditions to prepare a tertiary amine; and b) binding a compound comprising a C1-20 saturated or unsaturated chain group, a benzyl group, a hydroxy ethyl group, or a hydroxy ethyl group to which 1 to 20 ethylene oxide or propylene oxide groups are attached to the obtained tertiary amine, to cause quaternarization.

First, a secondary amine corresponding to the object of the present invention and a compound comprising a C1-20 saturated or unsaturated chain group, a benzyl group, a hydroxy ethyl group, or a hydroxy ethyl group to which 1 to 20 ethylene oxide or propylene oxide groups are attached are reacted while heating under basic conditions to prepared a tertiary amine, and then it is reacted with a linker of the above Chemical Formula 4 to cause quaternarization, one example of which is as shown in the following Equation 6. 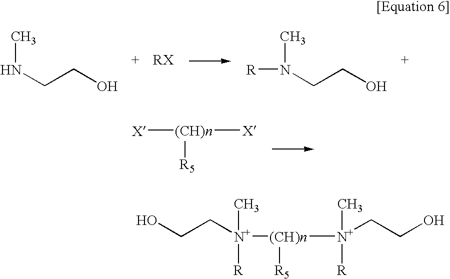
wherein R is a C1-20 saturated or unsaturated chain group, a benzyl group, a hydroxy ethyl group, or a hydroxy ethyl group to which 1 to 20 ethylene oxide or propylene oxide groups are attached; n is an integer of 1 to 20; X is a halogen atom, a sulfate group, or an acetate group; X′ is a halogen atom; and R₅ is hydrogen, or a C1-20 alkyl or allyl group comprising at least one double bond, hydroxyl group, or ether group.

Alternatively, a secondary amine corresponding to the object of the present invention is reacted with a compound of the above Chemical Formula 5 to synthesize a tertiary amine under alkaline conditions, and then it is reacted with a compound comprising a C1-20 saturated or unsaturated chain group, a benzyl group, a hydroxy ethyl group, or a hydroxy ethyl group to which 1 to 20 ethylene oxide or propylene oxide groups are attached, to quaternarize, one example of which is as shown in the following Equation 7. 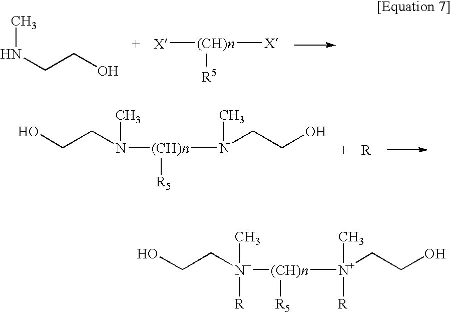
wherein R is a C1-20 saturated or unsaturated chain group, a benzyl group, a hydroxy ethyl group, or a hydroxy ethyl group to which 1 to 20 ethylene oxide or propylene oxide groups are attached; n is an integer of 1 to 20; X is a halogen atom, a sulfate group, or an acetate group; X′ is a halogen atom; and R₅ is hydrogen, or a C1-20 alkyl or allyl group comprising at least one double bond, a hydroxyl group, or an ether group.

Among the cationic compounds of Chemical Formula 4, bis-forms can be prepared through the pathway of the above Equations 6 or 7.

In addition, the cationic compound comprising 3 or more cationic groups in one molecule can be obtained by reacting an equal number of moles of a secondary amine and epichlorohydrin in an alcohol solvent to synthesize an intermediate, and then polymerizing the intermediate. The polymerization degree of the cationic compound can be controlled by controlling time and temperature of polymerization. The synthesis pathway of the cationic compound of such an oligomer or polymer form is as shown in the following Equation 8. 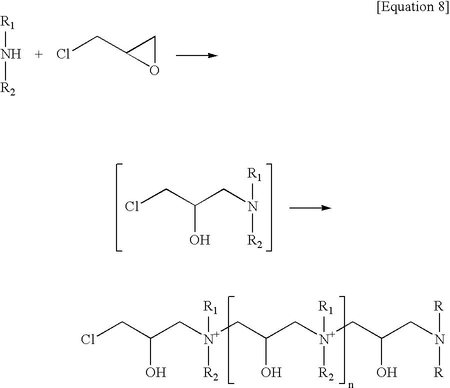
wherein R₁ and R₂ are as defined in the above, and n is an integer of 1 to 20.

In the present invention, a cationic compound can be easily synthesized by selecting an appropriate method according to a desired compound. The synthesized compound can be confirmed by NMR and MASS analyses.

The compound of Chemical Formula 3 comprising a cationic group is preferably selected from a group consisting of dimethyloctylethoxy ammonium, dimethyl decyl ethoxy ammonium, dimethyl lauryl ethoxy ammonium, dimethyloctylethanol (EO)₅ ammonium, dimethyldecylethanol (EO)₅ ammonium, dimethyllaurylethanol (EO)₅ ammonium, dimethyloctylethanol (EO)₁₀ ammonium, dimethyldecylethanol (EO)₁₀ ammonium, dimethyllaurylethanol (EO)₁₀ ammonium, dimethyloctylethanol (EO)₁₅ ammonium, dimethyldecylethanol (EO)₁₅ ammonium, dimethyllaurylethanol(EO)₁₅ ammonium, trimethyloctyl ammonium, tridecyllauryl ammonium, trimethyllauryl ammonium, 1,6-[2-(N-dimethylamino)ethanol]hexane, 1,6-[2-(N,N-ethylmethylamino)ethanol]hexane, 1,6-[2-(N,N-butylmethyl amino)ethanol]hexane, 1,6-[2-(N,N-methyloctylamino)ethanol]hexane, 1,6-[2-(N,N-dodecylmethyl amino)ethanol]hexane, 1,8-[2-(N-dimethylamino)ethanol]octane, 1,8-[2-(N,N-ethylmethylamino)ethanol]octane, 1,8-[2-(N,N-butylmethyl amino)ethanoljoctane, 1,8-[2-(N,N-methyloctylamino)ethanol]octane, 1,8-[2-(N,N-dodecylmethylamino)ethanol]octane, 1,6-[2-(N,N-dimethylamino)ethanol(EO)₂]hexane, 1,6-[2-(N,N-ethylmethylamino)ethanol(EO)₂]hexane, 1,6-[2-(N,N-butylmethylamino)ethanol(EO)₂]hexane, 1,6-[2-(N,N-methyloctylamino)ethanol(EO)₄]hexane, 1,6-[2-(N,N-dodecylmethylamino)ethanol(EO)₄]hexane, 1,6-[2-(N-dimethylamino)ethanol(EO)₄]hexane, 1,6-[2-(N-dimethylamino)ethanol(EO)₄]hexane, 1,6-[2-(N,N-ethylmethylamino)ethanol(EO)₄]hexane, 1,6-[2-(N,N-butylmethylamino)ethanol(EO)₄]hexane, 1,6-[2-(N,N-methyloctylamino)ethanol(EO)₄]hexane, 1,6-[2-(N,N-dodecylmethylamino)ethanol(EO)₄]hexane, 1,8-[2-(N-dimethylamino)ethanol(EO)₂]octane, 1,8-[2-(N,N-ethylmethylamino)ethanol(EO)₂]octane, 1,8-[2-(N,N-butylmethylamino)ethanol(EO)₂]octane, 1,8-[2-(N,N-methyloctylamino)ethanol(EO)₂]octane, 1,8-[2-(N,N-ethylmethylamino)ethanol(EO)₄]octane, 1,8-[p2-(N,N-butylmethylamino)ethanol(EO)₄]octane, 1,8-[2-(N,N-methyloctylamino)ethanol(EO)₄]octane, 1,8-(2-(N,N-dodecylmethylamino)ethanol(EO)₄]octane, 1,6-[2-(N-dimethylamino)ethanol(PO)₂]hexane, 1,6-[2-(N,N-ethylmethylamino)ethanol(PO)₂]hexane, 1,6-[2-(N,N-butylmethylamino)ethanol(PO)₂]hexane, 1,6-[2-(N,N-methyloctylamino)ethanol(PO)₂]hexane, 1,6-[2-(N,N-dodecylmethylamino)ethanol(PO)₂]hexane, 1,6-[2-(N-dimethylamino)ethanol(PO)₄]hexane, 1,6-[2-(N,N-ethylmethylamino)ethanol(PO)₄]hexane, 1,6-[2-(N,N-butylmethylamino)ethanol(PO)₄]hexane, 1,6-[2-(N,N-methyloctylamino)ethanol(PO)₄]hexane, 1,6-[2-(N,N-dodecylmethylamino)ethanol(PO)₄]hexane, 1,8-[2-(N-dimethylamino)ethanol(PO)₂]octane, 1,8-[2-(N,N-butylmethylamino)ethanol(PO)₄]octane, 1,8-[2-(N,N-methyloctylamino)ethanol(PO)₄]octane, 1,8-[2-(N,N-dodecylmethylamino)ethanol(PO)₄]octane, 1,8-[2-(N-dimethylamino)ethanol(PO)₄]octane, 1,8-[2-(N,N-ethylmethylamino)ethanol(PO)₄]octane, 1,8-[2-(N,N-butylmethylamino)ethanol(PO)₄]octane, 1,8-[2-(N,N-methyloctylamino)ethanol(PO)₄]octane, 1,8-[2-(N,N-dodecylmethylamino)ethanol(PO)₄]octane, and a mixture thereof.

In addition, the surfactant system of the present invention uses a compound that can be mixed with the compound of Chemical Formula 1, 2, or 4 to obtain a mixed system with superior phase stability as the anionic surfactant. For this, generally used anionic surfactant compounds can be applied, and particularly, a carboxylic acid salt compound such as soap, a higher alcohol, or an alkyl ether sulfated, an olefin-sulfonated alkali salts, a sulfonates comprising alkylbenzensulfonate, and a phosphates produced by phosphorylation of a higher alcohol can be used. Examples include sodium lauryl sulfonate SLS), sodium lauryl ether sulfonate (SLES), a linear alkyl benzene sulfonate (LAS), a monoalkyl phosphate (MAP), acyl isethionate (SCI), alkyl glyceryl ether sulfonate (AGES), acyl glutamate, acyl taurate, a fatty acid metal salt, etc., and preferably SLS, SLES, LAS, or SCI is used.

Also, the surfactant system of the present invention preferably uses a compound that is mixed with an anionic surfactant and the compound of Chemical Formula 1, 2, or 4 to show superior phase stability as a non-ionic surfactant. In the surfactant system of the present invention, the non-ionic surfactant is preferably selected from a group consisting of an alcohol ethoxylate, an alkyl phenol ethoxylate, alkylpolyglycosides, an amine oxide, an alkanolamide, and a mixture thereof.

Also, the surfactant system of the present invention preferably uses a compound that is mixed with an anionic surfactant and the compound of Chemical Formula 1, 2, or 4 to show superior phase stability as a cationic surfactant. As the cationic surfactant used in the present invention, a commonly used cationic surfactant can be used. For example, it is selected from a group consisting of an amine salt form compound, a compound comprising quaternary ammonium, a monoalkyl dimethyl amine derivative, a dialkyl monomethylamine derivative, an imidazoline derivative, a quaternary ammonium compound of a Geminic form, an oligomeric form, and a mixture thereof.

In the mixed system prepared under the above conditions, changes in physical properties of an anionic surfactant (for example, SLS) can be confirmed by measuring the changes of the Krafft point, foam properties (initial foam and foam-maintaining property), surface tension, and stability to hard water.

The surfactant system of the present invention improves the Krafft point when a surfactant is separated under a cooling condition to 0° C. or less, by mixing the compound of Chemical Formula 1, 2, or 4 with an anionic surfactant, which indicates that phase stability of the surfactant system is very superior at a low temperature.

Particularly, a compound of Chemical Formula 4 comprising a non-ionic group shows superior phase stability even if the mixing ratio is low. Therefore, a disadvantage of anionic surfactants, separation at low temperature, can be compensated by mixing the non-ionic compound of Chemical Formula 4 with an anionic surfactant, which can be helpful for maintaining phase stability of a product comprising the surfactant in the wintertime.

Also, as a result of testing foamability (initial foamability and foam stability), initial foamability of the mixed system is shown to be equal to an anionic surfactant, and foam stabilized for a long time regardless of mixing ratio, and although initial foam production is superior, foam gradually decreases as time passes. This means that foaming property of products can be controlled by selecting and applying a non-ionic compound to prescription according to products including dish washing detergent, shampoo, body cleanser, laundry detergent, etc.

As for a change in surface tension, it decreases as the mixing ratio of the non-ionic compound increases, and a constant surface tension is obtained even at a very low concentration, from which it can be predicted that a mixed system has a lower cmc than an anionic surfactant (SLS). Such low surface tension and cmc mean that even a small amount can show superior cleaning power.

Stability to hard water for the mixed system increases by about twice compared to using an anionic surfactant alone. Thus it can be applied to a product that requires cleaning with water comprising a lot of positive metal ions such as dish washing detergent or laundry detergent. Also, the increase in stability to hard water indicates that an anionic surfactant and non-ionic compound form a mixed micelle. As the anionic surfactant and non-ionic compound better form a mixed micelle, physical properties of a mixed surfactant can be sufficiently changed.

In addition, a non-ionic compound prepared using a secondary amine to which an average of 2 to 15 moles of ethylene oxide (EO) or propylene oxide (PO) are added can form a mixed system with a non-ionic surfactant or a mixture of an anionic surfactant and a cationic surfactant to change physical properties.

Also, the surfactant system of the present invention improves the Krafft point when a surfactant is separated under a cooling condition to 0° C. or less, by mixing a cationic compound of Chemical Formula 3 with an anionic surfactant, which indicates that phase stability of the surfactant system is superior at low temperatures.

For the Krafft point, the mixed system of the present invention shows 0° C. or less under most sample conditions, which indicates that it is hardly influenced by the length of an alkyl group of a cationic compound and the mixing ratio. Therefore, a disadvantage of an anionic surfactant, separation at low temperatures, can be compensated by mixing the cationic additive with an anionic surfactant, which can be a large help in maintenance of phase stability of products in the wintertime.

In addition, in the case of a mixed system comprising a cationic compound, results of testing foamability (initial foamability and foam stability) show that as an alkyl group of the cationic compounds becomes longer, when the mixing ratio is 2/0.75 or more, initial formability of a mixed system decreases and foam-stability becomes lower. This is a property required for dishwashing detergent or laundry detergent for a drum washer in which plenty of foam is initially produced like an anionic surfactant and foam is easily broken down as used. Particularly, in the case of a mixed system using a cationic compound in which a dodecyl group is introduced as an alkyl group, little foam is produced. From these results, it can be seen that a cationic compounds can be applied as an antifoaming agent for a prescription of a product comprising an anionic surfactant as a main compound (for example, for a low foaming washing detergent, etc.).

For a change in surface tension, in the case a mixing ratio is 2/0.1 or more, as the mixing ratio of the cationic compound increases, surface tension decreases, and a constant surface tension is maintained even at low concentration, from which it can be predicted that a mixed system can have a lower cmc than an anionic surfactant (SLS). Such low surface tension and cmc means that even if with a small amount of cationic compound can increase cleaning property.

The mixed system shows very improved stability to hard water in the case of a cationic compound having an alkyl group of a butyl group or more, or in the case the mixing ratio with an anionic surfactant is 2/0.5 or more. Particularly, in the case when a cationic compound includes a butyl group, a mixed system shows a stability to hard water increase of approximately 4 times compared to using an anionic surfactant alone. Thus, it can be applied for products for cleaning using water comprising many positive metal ions such as for dish washing detergent or laundry detergent. Also, an increase in stability to hard water indicates that ionicity of the anionic surfactant binds with cationic compounds to form a complex. As an anionic surfactant and a cationic compound bind strongly, a smaller amount of a cationic compound can sufficiently change physical properties of an anionic surfactant.

In order to compare capacities of the cationic compound of Chemical Formula 4 for changing physical properties of an anionic surfactant, quaternary ammonium compounds comprising alkyl groups of the same length and a hydroxy ethyl group were prepared and physical properties were evaluated under the same conditions. As results, the cationic compound of the present invention showed a lowered Krafft point, an improved foam-controlling power, a lowered surface tension, and improved stability to hard water even with a low mixing ratio compared to a control. From these results, it can be seen that as cationic groups in one molecule increase, a capacity for changing physical properties of an anionic surfactant is improved.

In addition, when a cationic compound of Chemical Formula 2 or 4 is prepared using a secondary amine in which an average of 2 moles of ethylene oxide (EO) and 4 moles of propylene oxide (PO) are added to a hydroxyl group, the capacity for changing physical properties of an anionic surfactant can also be improved.

As explained, the mixed surfactant system of the present invention in which a compound of the above Chemical Formula 1, 2, or 4 and an anionic surfactant are mixed has very superior surface active effects, and thus, if included in solid, liquid, gel, or paste types detergents, for examples, products such as shampoo, skin cleanser, soap, dish washing detergent, house detergent, industrial detergent, toothpaste, powder detergent, etc. and additive prescriptions, products with effects superior to the conventional products can be provided.

The present invention will be explained in more detail with reference to the following Examples. However, these are to illustrate the present invention, and the present invention is not limited to them.

### EXAMPLE

1-1-1. Synthesis of Mono-Type Quaternary Ammonium Cationic Compound

5 kinds of mono-type compounds comprising one quaternary ammonium group as a representative cationic group that changes physical properties of an anionic surfactant in a mixed system with the anionic surfactant, and 2 kinds of compounds in which ethylene oxide (EO) is added to a hydroxyl group of a mono-type compound as a non-ionic hydrophilic group were synthesized by the following method.

### Synthesis Example 1

Synthesis of N-(dimethyldodecylamino)ethanol

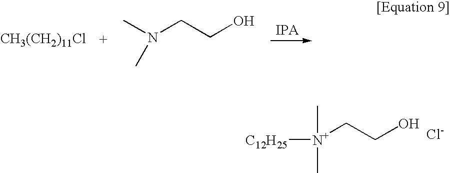

To a three-necked flask, isopropyl alcohol (IPA; 40 g), dodecyl chloride (153 g; 0.75 mol), and 2-(dimethylamino)ethanol (44.6 g; 0.5 mol) were introduced, and sodium iodide (2.4 g) was added as a catalyst and then the mixture was refluxed. Amount of amine was measured to confirm the reaction. 5 hours after elevating the temperature of the reactor to 120° C., the reaction proceeded over 95%. The reaction product was mixed with acetone and cooled to be crystallized. After recrystallization, the product obtained by filtration was immediately dried in vacuum.

Molecular weight: 293 g/mol

Yield: 67%, white solid

Solubility: very strong hygroscopicity, insoluble in acetone

Mass spectrometry (FAB+, m/e): 551, 258 [M-Cl]+, 265

¹H NMR(solvent; D₂O, ppm): 0.8620[3H], 1.2832[18H], 1.6276[2H], 3.1601 [6H], 3.3645[2H], 3.4859[2H], 4.0124[2H]

Elementary analysis: C16H36ONCl

Theoretical value: C 65.38%, H 12.35%, N 4.77%

Calculation value: C 64.00%, H 12.80%, N 5.60%

### Synthesis Example 2

Synthesis of N-(dimethyloctylamino)ethanol

To a three-necked flask, IPA (18.7 g), octyl chloride (66.9 g; 0.45 mol), and 2-(dimethylamino)ethanol (26.74 g; 0.3 mol) were introduced and the reactor was heated to reflux the mixture. Amount of amine was measured to confirm the reaction. 6 hours after elevating the temperature of the reactor to 110° C., the reaction proceeded over 95%. The reaction product was mixed with acetone and cooled to be crystallized. The recrystallized product was filtered and then immediately dried in vacuum.

Molecular weight: 238 g/mol

Yield: 42%, white solid

Solubility: very strong hygroscopicity, insoluble in acetone

Mass spectrometry (FAB+, m/e): 439, 202[M-Cl], 200

### Synthesis Example 3

Synthesis of N-(butyidimethylamino)ethanol

To a three-necked flask, IPA (29 g), 1-chlorobutane (70 g; 0.75 mol) and 2-(dimethylamino)ethanol (44.6 g; 0.5 mol) were introduced, and NaI (1.4 g) was added as a catalyst and then a reactor was heated to reflux the mixture. Amount of amine was measured to confirm the reaction, and the reaction was continued for 21 hours. The reaction product was mixed with acetone and cooled to be crystallized, and the recrystallized product was filtered and then immediately dried in vacuum.

Molecular weight: 182 g/mol

Yield: 85%, white solid

Solubility: very strong hygroscopicity, insoluble in acetone

Mass spectrometry (FAB+, m/e): 327,146[M-Cl]⁺

¹H NMR(solvent; D₂O, ppm): 0.9657[3H], 1.3837[2H], 1.7449[2H], 3.1427[6H], 3.3831[2H], 3.4904[2H], 4.0445[2H]

Elementary analysis: C₈H₂₀ONCl

Theoretical value; C 52.88%, H 11.09%, N 7.71%

Calculation value; C 52.20%, H 11.70%, N 7.30%

### Synthesis Example 4

Synthesis of N-(dimethylethylamino)ethanol

To a three-necked flask, IPA (40 g), iodo ethane (117 g; 0.75 mol), and 2-(dimethylamino)ethanol (44.6 g; 0.5 mol) were introduced and NaI (2 g) was added as a catalyst and then a reactor was heated to reflux the mixture. The reaction product was poured into n-hexane and then cooled to be crystallized, and the crystallized product was filtered and immediately dried in vacuum.

Molecular weight: 245 g/mol

Yield: 110 g (90%) yellow solid

Solubility: very strong hygroscopicity, soluble in acetone, insoluble in n-hexane.

Mass spectrometry: (FAB+, m/e): 363,118[M-I]⁺

¹H NMR (solvent; D₂O, ppm): 1.3763[3H], 3.1266[6H], 3.4672[2H+2H], 4.0457[2H]

Elementary analysis: C₆H₁₆ONI

Theoretical value; C 29.4%, H 6.6%, N 5.7%

Calculation value; C 28.8%, H 6.9%, N 5.2%

### Synthesis Example 5

Synthesis of N-(trimethylamino)ethanol

To a three-necked flask, IPA (37 g), iodo methane (142 g; 1.0 mol), and 2-(dimethylamino)ethanol (44.6 g; 0.5 mol) were introduced and mixed to complete a reaction. At this time, simultaneously with adding the reactants, an exothermic reaction occurred to complete the reaction. The reaction product was poured into acetone and then cooled to be crystallized, and the crystallized product was filtered and then immediately dried in vacuum.

Molecular weight: 231 g/mol

Yield: 76%; white solid

solubility: very strong hygroscopicity, insoluble in acetone

Mass spectrometry (FAB+, m/e): 335, 154, 104[M-I]⁺

¹H NMR (solvent; D₂O, ppm): 3.1876[9H], 3.5024[2H], 4.0540[2H]

Elementary analysis: C₅H₁₄ONI

Theoretical value; C 25.99%, H 6.11%, N 6.11%

Calculation value; C 26.19%, H 6.27%, N 5.64%

1-1-2. Synthesis of Compound wherein Non-Ionic Group (EO) is Bound to Mono-Type Cationic Compound

### Synthesis Example 6

Synthesis of N-dimethyldodecylamino)ethanol (EO)2

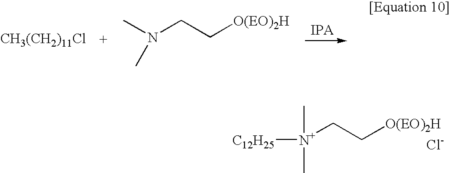

To a three-necked flask, IPA 47.6 g, dodecyl chloride (91.8 g; 0.45 mol), and 2-(dimethylamino)ethanol (EO)₂ (79 g; 0.3 mol) were introduced and NaI (1.7 g) was added as a catalyst. 7 hours after elevating the temperature to 110° C., the reaction proceeded over 95%. The product was separated and purified using column chromatography with silica gel.

Molecular weight: 382 g/mol

Yield: 26%; transparent oil

Solubility: very strong hygroscopicity, soluble in acetone

Mass spectrometry (FAB+, m/e): 478[EO=5], 434[EO=4], 390[EO=3], 346[EO=2], 302[EO=1], 258[EO=0]

### Synthesis Example 7

Synthesis of N-(dimethyldodecylamino ethanol (EO)₄

To a three-necked flask, IPA (47.6 g), dodecyl chloride (92 g; 0.45 mol), and 2-(dimethylamino)ethanol (EO)₄ (143.7 g; 0.3 mol) were introduced and NaI (2.4 g) was added as a catalyst, and then after elevating the temperature to 110° C., the reaction was proceeded for 12 hours. The reaction product was separated and purified using column chromatography with silica gel.

Molecular weight: 507 glmol

Yield: 21%; light brown oil

Solubility: very strong hygroscopicity, soluble in acetone

Mass spectrometry (FAB+, m/e): 610[EO=8], 566[EO=7], 522[EO=6], 478[EO=5], 434[EO=4], 390[EO=3], 346[EO=2], 302[EO=1]

1-2. Studies for Changes in Physical Properties of SLS of a Mixed System when Mixing SLS with Cationic Compounds of Mono-Type Quaternary Ammonium Forms (Synthesis Examples 1 to 5) and Cationic Compounds in which a Non-Ionic Group is Added to a Mono-Type (Synthesis Examples 6, 7)

### Examples 1 to 7

Sodium lauryl sulfate (SLS; Sigma reagent; molecular weight 288 g/mol), a cationic compound prepared in the above Synthesis Examples 6 to 12, and alkanolamide were mixed in a mole ratio of 1:1:0.001. Concentration of a mixed system was controlled to 2% aqueous solution, and a mixing ratio of SLS and the cationic compound was controlled to 1:1 by mole ratio so that changes in physical properties could be remarkably shown (Table 1).

TABLE 1
Sample conditions when measuring Krafft point and foaming property

| | Added amount per 100 ml of water (g), | | | | | | | |
|---|---|---|---|---|---|---|---|---|
| | (mole ratio of SLS: cationic compound = 1:1) | | | | | | | |
| | SLS | compound 1 | compound 2 | compound 3 | compound 4 | compound 5 | compound 6 | compound 7 |
| Example 1 | 0.98 | 1.02 | — | — | — | — | — | — |
| Example 2 | 1.10 | — | 0.90 | — | — | — | — | — |
| Example 3 | 1.22 | — | — | 0.78 | — | — | — | — |
| Example 4 | 1.07 | — | — | — | 0.93 | — | — | — |
| Example 5 | 1.10 | — | — | — | — | 0.90 | — | — |
| Example 6 | 0.86 | — | — | — | — | — | 1.14 | — |
| Example 7 | 0.76 | — | — | — | — | — | — | 1.24 |

[Experiment 1]

In order to measure changes in physical properties in the mixed systems of Examples 1 to 7, changes in Krafft point, initial foamability, foam stability, stability to hard water, cmc, and surface tension were measured.

1) Measurement of Krafft Point

In the Krafft point test, the temperature when the solution clouded through the previous test becomes transparent again while elevating the temperature were measured. The results show that, as cloudiness begins at a lower temperature and the solution becomes transparent at a lower temperature, the solution maintains a more stable condition. Samples of Examples 1, 2, 6, and 7 showing cloudiness when mixing were not tested, but samples of Examples 3 to 5 were tested. Test results are as shown in the following Table 2.

TABLE 2
Results of measuring change in Krafft point in a mixed system

| | When lowering | When elevating |
|---|---|---|
| | temperature(° C.) | temperature(° C.) |
| Example 3 | <0 | — |
| Example 4 | <0 | — |
| Example 5 | <0 | — |

As shown in Table 2, Examples 3 to 5 improved the Krafft point to under 0° C. when compared to SLS alone. This indicates that in most liquid detergents of aqueous solution phases, the surfactant is not separated from the solution even at a low temperature and it can maintain a stable phase.

2) Measurement of Initial Foamability and Foam Stabilty in a Mixed System

As samples for measuring initial foamability and foam stability, samples prepared under the same conditions as those used for measuring Krafft point were used (Table 14). However, samples of Examples 1, 2, 6, and 7 showing cloudiness when mixing were not tested, and samples of Examples 3 to 5 were tested. The semi-micro TK method was used for measurement, and mean values were taken after measuring three times. Results of measuring foaming property are as shown in Table 3.

TABLE 3
Results of initial foamability and foam stability (unit: ml)

| | 0 min. | 1 min. | 2 min. | 3 min. | 4 min. | 5 min. |
|---|---|---|---|---|---|---|
| Example 3 | 115 | 38 | 10 | 10 | 10 | 10 |
| Example 4 | 140 | 65 | 35 | 10 | 10 | 10 |
| Example 5 | 155 | 95 | 60 | 50 | 40 | 40 |

As shown in Table 3, Examples 3 to 5 showed almost the same level of initial foamability with SLS alone. However, in the test measuring foam stability, the mixed systems of Examples 3 to 5 showed results that foam disappeared only after 2 minutes. Also, as the alkyl group of the cationic compound becomes longer, foam stability became lower.

As can be seen from these results, the mixed systems of Examples 3 to 5 of the present invention maintain initial foamability of the anionic surfactant while produced foam can be removed within a short time, and the cationic compound has very superior effects for inhibiting foam maintenance.

3) Evaluation of Stability to Hard Water

After dissolving 11.69 g of CaCl2.2H₂O in 1 liter of water to prepare hard water of 10,000 ppm, it was slowly added to a 0.5% aqueous solution sample, and stability to hard water was evaluated using the amount of hard water added until cloudiness began. The results are shown in Table 4. Samples of Examples 1, 2, 6, and 7 showing cloudiness when mixing were not tested.

TABLE 4
Results of stability to hard water

| | | Hard water |
|---|---|---|
| Sample (0.5% aqueous | Added amount of 10,000 ppm | concentration |
| solution) | hard water (ml) | (ppm) |
| Example 3 | 6.6 | 619 |
| Example 4 | 2.8 | 272 |
| Example 5 | 3.0 | 291 |

As shown in Table 4, Example 3 showed improved of about twice that of SLS alone, and Examples 4 and 5 showed levels of stability to hard water very similar to that of SLS.

4) Measurement of Changes in Surface Tension and cmc in a Mixed System

Changes in surface tension and cmc in the mixed systems of Examples 1 to 7 were measured using a processor tensiometer K12 from the Kruss Company. Samples of which surface tensions were to be measured were prepared by mixing SLS and a cationic compound in a mole ratio of 1:1, wherein deionized water was used as water, and a container for measurement was immersed in a cleaning solution for more than 3 hours, washed with water and acetone, dried in an oven, and then used. Results of measuring surface tension and cmc are shown in Table 5.

TABLE 5
Results of measuring changes in surface tension and cmc (25° C.)

| | | Surface tension |
|---|---|---|
| | cmc (10⁻³ M) | (mN/m) |
| Example 1 | 0.06 | 25 |
| Example 2 | 0.84 | 29 |
| Example 3 | 3.3 | 35 |
| Example 4 | 3.8 | 38 |
| Example 5 | 5.8 | 39 |
| Example 6 | 0.11 | 26 |
| Example 7 | 0.2 | 36 |

As can be seen from Table 5, the mixed systems of Examples 1 to 7 mixing SLS and cationic compounds showed decreased surface tensions by 13-44% compared to SLS. Particularly, the mixed systems of Examples 1, 2, 6, and 7 showed results that cmc became thinner by 10 to 100 times. This means that even a small amount can show superior surface active effects.

2-1. Bis-Type Cationic Compound Comprising Two Cationic Groups in Molecule

2-1-1. Synthesis of Cationic Compound

An appropriate synthesis pathway was selected according to linker length and alkyl group length as in Equations 1 to 3 or Equations 6 to 7, to prepare desired cationic compounds.

### Synthesis Example 8

Synthesis of 1,6-[2-(N-methylamino)ethanol]hexane

To 40 g of IPA, 45 g of 2-(methylamino) ethanol (0.6 mol), 46.5 g of 1,6-dichlorohexane (0.3 mol), and 48 g of Na₂CO₃ were mixed, and the mixture was refluxed for 25 hours. The product was filtered, distilled under reduced pressure, and vaccum-dried to purify it.

Molecular weight: 232 g/mol

Phase: oil phase

¹H NMR(CDCl₃, δ ppm): 1.07(4H), 1.28(4H), 2.20(6H), 2.37(4H), 2.47(4H), 3.41 (4H)

Mass (FAB+): m/e 233[M+H]⁺

### Synthesis Example 9

Synthesis of 1,6-[2-(N,N-dimethylamino)ethanol]hexane (using Equation 1)

To 20 g of IPA, 23.2 g of 1,6-[2-(N-methylamino)ethanol]hexane (0.1 mol), 42.6 g of iodomethane (0.3 mol), and 5 g of NaI were mixed, and then reaction was proceeded at room temperature for 2 hours. Then, the product was filtered, distilled under reduced pressure, dried in vacuum, and crystallized with acetone to purify it.

Molecular weight: 262 g/mol

Phase: yellow powder (hygroscopicity)

¹H NMR(D₂O, δ ppm): 1.20(4H), 1.83(4H), 3.16(12H), 3.38˜3.55(8H), 4.06(4H)

Mass (FAB+): m/e 389[M2⁺⁺I]^{+,} 297, 261, 247, 217

### Synthesis Example 10

Synthesis of 1,6-[2-(N,N-ethylmethylamino)ethanol]hexane (using Equation 1)

To 20 g of IPA, 15.11 g of 1,6-[2-(N-methylamino)ethanol]hexane (0.065 mol), 30.5 g of iodoethane (0.195 mol), and 3 g of NaI were mixed and the mixture was refluxed for 9 hours. Then, the product was filtered, distilled under reduced pressure, dried in vacuum, and crystallized with acetone to purify it.

Molecular weight: 290 g/mol

Phase: yellow powder (hygroscopicity)

¹H MR(D₂O, δ ppm): 1.35(4H), 1.45(4H), 2.97(6H), 3.37(10H), 3.47(8H), 4.04(4H)

Mass (FAB+): m/e 417[M2⁺⁺I]⁺

### Synthesis Example 11

Synthesis of 1,6-[2-(N,N-butylmethylamino)ethanol]hexane (using Equation 2)

To 11 g of IPA, 20.5 g of 2-(N,N-butylmethylamino)ethanol (0.156 mol), 12.1 g of 1,6-dichlorohexane (0.078 mol), 33 g of Na2 CO3, and 5 g of NaI were mixed and the mixture was refluxed for 14 hours. Then, the product was filtered, distilled under reduced pressure, dried in vacuum, and crystallized with acetone to purify it.

Molecular weight: 346 g/mol

Phase: oil phase

¹H NMR(D₂O, δ ppm): 1.00(6H), 1.41(8H), 1.75(8H), 3.10(6H), 3.34˜3.51(12H), 4.04(4H)

Mass (FAB+): m/e 381 [M₂⁺⁺Cl^{-]}⁺

### Synthesis Example 12

Synthesis of 1.6-12-(N,N-methyloctylamino)ethanollhexane (using Equation 2)

To 6 g of IPA, 18.76 g of 2-(N,N-methyloctylamino)ethanol (0.1 mol), 7.8 g of 1,6-dichlorohexane (005 mol), 2.2 g of Na2CO3, and 2.5 g of NaI were mixed and then the mixture was refluxed for 22 hours. The product was filtered, distilled under reduced pressure, and dried in vacuum to purify it.

Molecular weight: 458 g/mol

Phase: oil phase

¹H NMR(D₂O, δ ppm): 0.89(6H), 1.31(24H), 1.77(8H), 3.10(6H), 3.36(8H), 4.49(4H), 4.04(4H)

Mass (FAB+): m/e 493[M2⁺⁺Cl]⁺

### Synthesis Example 13

Synthesis of 1,6-[2-(N N-dodecylmethylamino)ethanol]hexane (using Eguation 2)

To 10 g of IPA, 18.69 g of 2-(N,N-dodecylmethylamino)ethanol (0.077 mol), 6 g of 1,6-dichlorohexane (0.39 mol) and 3 g of NaI were mixed, and the mixture was refluxed for 20 hours. The product was filtered, distilled under reduced pressure, and dried in vacuum to purify it.

Molecular weight: 570 g/mol

Phase: oil phase

¹H NMR(D₂O, δ ppm): 0.94(6H), 1.20(40H), 1.82(8H), 3.20(6H), 3.59(8H), 3.69(4H), 4.09(4H)

Mass (FAB+): m/e 605[M2⁺⁺Cl⁻]⁺

[Experiment 2]

2-2. Measurement of Changes in Effects of Anionic Surfactant in a Mixed System of Anionic Surfactant and Cationic Compound

As an anionic surfactant for measuring physical properties, sodium lauryl sulfate (SLS; Aldrich Company reagent; purity 99% or more) was used.

Additionally, as a cationic compound, compounds having an n value of 6 among the cationic compounds of the following Chemical Formula 2a were used (Table 6).

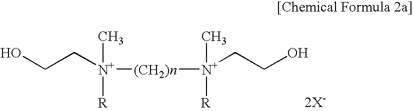

(wherein R is a C1-C12 alkyl group and n is 6.)

TABLE 6
Kinds and molecular weight of cationic compounds (n = 6)

| | Synthesis | Synthesis | Synthesis | Synthesis | Synthesis |
|---|---|---|---|---|---|
| | Example 14 | Example 15 | Example 16 | Example 17 | Example 18 |
| Compound(R/X) | C₁/I | C₂/I | C₄/Cl | C₈/Cl | C₁₂/Cl |
| Molecular | 516 | 644 | 374 | 486 | 598 |
| weight(g/mol) | | | | | |

Glass used in the following experiment was immersed in a cleaning solution (KOH+IPA+water) for more than 4 hours, and washed with distilled water and acetone, dried, and then used. Deionized water was used for measurement.

Changes in physical properties of the anionic surfactant were measured for changes in Krafft point, initial foamability, foam stability, stability to hard water, surface tension, etc.

2-2-1. Measurement of Physical Properties of Cationic Compound

1) sample Conditions

1 g each of the cationic compounds of Synthesis Examples 14 to 18 were dissolved in 99 g of water to make samples of 1 wt % concentration to be used for measurement. The samples having C1, C2, and C4 alkyl groups were transparent, but the samples having C8 and C12 alkyl groups showed cloudiness. When the carbon number of the alkyl group was C8, the solution became transparent at 0.1 wt %, and when it was C12, the solution became transparent at 0.01 wt %.

2) Measurement of Krafft Point of Cationic Compound

The temperature when cloudiness begins was measured while cooling the transparent cationic compound solution (condition of lowering temperature). Additionally, the temperature when the solution becomes transparent was measured while elevating the temperature of the cloudy solution (condition of elevating temperature).

SLS showed results that cloudiness occurred at 2˜3° C. when lowering the temperature, and the solution became transparent again at 14° C. when elevating the temperature. Meanwhile, cationic compounds of the present invention did not show cloudiness even at 0° C. when lowering the temperature. In cases where cloudiness did not occur at 0° C., tests of elevating temperature were not conducted.

3) Measurement of Foaming Property (Initial Foamability and Foam Stability)

Foamability-related tests were conducted using a semi-micro TK method, and the results are shown in Table 7. The tests were repeated three times and a mean value was taken. A 1% solution was used in the tests, and in the case of Synthesis Example 18, a cloudy solution was used for measurement.

TABLE 7
Results of measuring foaming property of cationic compounds (unit ml)

| (ml) | | 0 min. | 1 min. | 2 min. | 3 min. | 4 min. | 5 min. |
|---|---|---|---|---|---|---|---|
| Synthesis Example 14 | C₁ | No foaming | | | | | |
| Synthesis Example 15 | C₂ | No foaming | | | | | |
| Synthesis Example 16 | C₄ | No foaming | | | | | |
| Synthesis Example 17 | C₈ | No foaming | | | | | |
| Synthesis Example 18 | C₁₂ | 213 | 203 | 190 | 128 | 120 | 105 |

As shown in Table 7, Synthesis Examples 14 and 16, cationic compounds having short alkyl chains, did not produced foam, but Synthesis Example 18 produced a comparatively weak foam with initial foamability of 213 ml and foam stability after 5 minutes of 105 ml.

4) Measurement of Surface Tension

Surface tensions of cationic compounds of Synthesis Examples 14 to 18 were measured using a tensiometer K12 of the Kruss Company. A ring method was used, and after measuring 5 times, a mean value was taken. Solutions of 1%, 0.1%, 0.01%, and 0.001% by weight ratio of each of the cationic compounds were prepared to use for the tests. Results of surface tension are shown in Table 8.

TABLE 8
Results of measuring surface tension
of cationic compound (unit: mN/m)

concentration

| | | 1% | 0.1% | 0.01% | 0.001% |
|---|---|---|---|---|---|
| Synthesis | C₁ | 59.49 | 70.04 | 71.41 | — |
| Example | | | | | |
| 14 | | | | | |
| Synthesis | C₂ | 61.35 | 68.63 | 71.53 | — |
| Example | | | | | |
| 15 | | | | | |
| Synthesis | C₄ | 37.45 | 51.95 | 61.98 | — |
| Example | | | | | |
| 16 | | | | | |
| Synthesis | C₈ | 27.91 | 33.90 | 47.50 | — |
| Example | | | | | |
| 17 | | | | | |
| Synthesis | C₁₂ | 30.30 | 30.70 | 30.85 | 47.44 |
| Example | | | | | |
| 18 | | | | | |

As shown in Table 8, Synthesis Example 18 showed a comparatively low surface tension in the measurement sample concentration range, but other cationic compounds showed high surface tension values.

5) Measurement of Stability to Hard Water

Hard water of 10,000 ppm prepared by dissolving 11.69 g of CaCl2.2H₂O in 1 L of water was used for the tests. Stability to hard water was measured by adding hard water until pearl is appear, using 0.5% (weight ratio) of the cationic compound and 100 ml of the sample. This test was repeated by three times, and a mean value was taken. Since the cationic compound does not carry a negative charge, precipitation was not produced in hard water. However, C12 showed cloudiness at 0.5%, and it was not measured.

2-2-2. Measurement of Changes in Physical Properties of SLS of Mixed System of Anionic Surfactant (SLS) and Cationic Compound of Synthesis Example 14 (R═CI/n=6)

### Examples 8 to 13

Sample solutions were prepared with mole ratios of the anionic surfactant (SLS) and the cationic compound of Synthesis Example 14 as shown in Table 9, and all the prepared sample solutions were transparent. A non-ionic surfactant alkanolamide was added so that its mole ratio for SLS became 1:0.001.

TABLE 9
Mixed system measuring sample

| | Example 8 | Example 9 | Example | Example | Example | Example 13 |
|---|---|---|---|---|---|---|
| Mixed | 2/1.0 | 2/0.75 | 2/0.5 | 2/0.25 | 2/0.1 | 2/0.01 |
| amount/rat | | | | | | |
| SLS/C1(g) | 0.53/0.47 | 0.60/0.40 | 0.69/0.31 | 0.82/0.18 | 0.92/0.08 | 0.991/0.009 |
| Phase | transparent | transparent | transparent | transparent | transparent | transparent |
| stability | | | | | | |

[Experiment 3]

1) Measurement of Krafft Point

Krafft points of Examples 8 to 13 (mixed systems of SLS and cationic compound) were measured, and the results are shown in Table 10.

TABLE 10
Measurement of Krafft point of mixed systems (unit ° C.)

| | Example 8 | Example 9 | Example [symbol] | Example [symbol] | Example [symbol] | Example [symbol] |
|---|---|---|---|---|---|---|
| When lowering | <0 | <0 | <0 | <0 | <0 | −0.5 |
| temperatur [symbol] | | | | | | |
| When elevating | — | — | — | — | — | 13 |
| temperatur [symbol] | | | | | | |

As shown in Table 10, Krafft points of all the samples were lowered to 0° C. or less. However, in the case of Example 13 with a mixing ratio of 2/0.01, the solution became opaque at −0.5° C., and when elevating the temperature, it became transparent again at 13° C., which indicates that solubility (stability) at low temperature was improved compared to SLS. In the case of other samples maintaining transparency even at 0° C. or less, measurement of Krafft point while elevating temperature could not be conducted.

2) Measurement of Foaming Property (Initial Foamability and Foam Stability)

Results of measuring foaming property are shown in Table 11.

TABLE 11
Results of measuring foaming property of mixed system (unit ml)

| | 0 min. | 1 min. | 2 min. | 3 min. | 4 min. | 5 min. |
|---|---|---|---|---|---|---|
| Example 8 | 175 | 118 | 80 | 65 | 58 | 53 |
| Example 9 | 193 | 160 | 128 | 100 | 85 | 78 |
| Example 10 | 223 | 205 | 185 | 180 | 175 | 175 |
| Example 11 | 218 | 210 | 210 | 205 | 203 | 195 |
| Example 12 | 225 | 223 | 220 | 220 | 220 | 218 |
| Example 13 | 238 | 233 | 230 | 230 | 230 | 223 |

As shown in Table 11, as the mixing ratio of the cationic compound becomes lower, the initial foamability and foam stability tended to become more similar to those of SLS. In Examples 8, 9, and 10, initial foamability decreased and foam was broken easily. For other mixing ratios, as the mixing ratio of the cationic compounds increased, initial foamability and foam stability slightly decreased, but a significant difference was not shown.

3) Measurement of Surface Tension

Results of measuring surface tension are shown in Table 12.

TABLE 12
Results of measuring surface tension change
of mixed system (room temperature)

| | Concentration | | |
|---|---|---|---|
| | 1% | 0.1% | 0.01% |
| Example 8 | 35.04 | 36.24 | 36.45 |
| Example 9 | 33.12 | 36.27 | 36.32 |
| Example 10 | 36.8 | 37.08 | 36.6 |
| Example 11 | 35.43 | 37.29 | 36.11 |
| Example 12 | 35.47 | 31.76 | 45.66 |
| Example 13 | 35.7 | 25.86 | 48.12 |

As shown in Table 12, Example 13 showed almost the same surface tension value as SLS, but as the mixing ratio of the cationic compound increased, the surface tension ended to decrease. The results that the surface tension decreased and there was no change at a low concentration mean that cmc is low, which indicates that only a small amount of the compound can show superior effects to cleaning.

4) Measurement of Stability to Hard Water for Mixed System

Results of measuring stability to hard water for a mixed system are shown in Table 13.

TABLE 13
Measurement of change in stability to hard water for mixed system

| | Example 8 | Example 9 | Example 10 | Example 11 | Example 12 | Example 13 |
|---|---|---|---|---|---|---|
| | 2/1.0 | 2/0.75 | 2/0.5 | 2/0.25 | 2/0.1 | 2/0.01 |
| 1^{st} | 8.6 | 5.1 | 3.2 | 2.3 | 2.0 | 2.4 |
| 2^{nd} | 8.4 | 5.2 | 3.4 | 2.3 | 1.9 | 2.4 |
| Mean(ml) | 8.5 | 5.15 | 3.3 | 2.3 | 1.95 | 2.4 |
| Hard water | 780 | 490 | 320 | 220 | 190 | 230 |
| concentration | | | | | | |
| (ppm) | | | | | | |

As shown in Table 13, as the mixing ratio of the cationic compound increases, the added amount of hard water increased. However, the difference between stabilities to hard water of Examples 8 and 13 was approximately 2 times.

2-2-3. Measurement of Changes in Physical Properties of SLS in a Mixed System of SLS and Cationic Compound of SYNTHESIS Example 15 (R═C2/n=61

### Examples 14 to 19

An anionic surfactant and the cationic compound of Synthesis Example 15 (R═C2/n=6) were mixed in a mole ratio as shown in Table 14 to prepare mixed system samples to be used for measurement, and all the prepared sample solutions were transparent. At this time, a non-ionic surfactant ethoxylated fatty alcohol was added so that mole ratio for SLS became 1:1.

TABLE 14

| | Example 14 | Example 15 | Example 16 | Example 17 | Example 18 | Example 19 |
|---|---|---|---|---|---|---|
| Mole ratio | 2/1.0 | 2/0.75 | 2/0.5 | 2/0.25 | 2/0.1 | 2/0.01 |
| SLS/C₂(g) | 0.51/0.49 | 0.59/0.41 | 0.68/0.32 | 0.81/0.19 | 0.91/0.09 | 0.99/0.01 |
| Phase | transparent | transparent | transparent | transparent | transparent | transparent |
| stability | | | | | | |

[Experiment 4]
Measurement of Physical Properties of Examples 14 to 19

1) Measurement of Change in Krafft Point of Mixed System

As results of measuring change in Krafft point of a mixed system, it as found that the Krafft point of a mixed system tended to decrease (Table 15). Samples with a mixing ratio of 2/0.25 or more showed results at 0° C. or less under a temperature drop condition, and those with a mixing ratio of 2/0.25 or less showed that the Krafft point decreased compared to SLS.

TABLE 15

| | Example 14 | Example 15 | Example 16 | Example 17 | Example 18 | Example 19 |
|---|---|---|---|---|---|---|
| Mole ratio | 2/1.0 | 2/0.75 | 2/0.5 | 2/0.25 | 2/0.1 | 2/0.01 |
| SLS/C₂(g) | <0 | <0 | <0 | <0 | 0 | 0.5 |
| Phase | X | X | X | X | 11˜13 | 12˜14 |
| stability | | | | | | |

2) Measurement of Changes in Initial Foamability and Foam Stability of Mixed System

The results of measuring changes in initial foamability and foam stability of a mixed system are shown in Table 16.

TABLE 16
Measurement of changes in initial foamability and foam stability

| | Mole | 0 | 1 | 2 | 3 | 4 | 5 |
|---|---|---|---|---|---|---|---|
| | ratio | min. | min. | min. | min. | min. | min. |
| Example | 2/1.0 | 208 | 165 | 55 | 45 | 40 | 40 |
| 14 | | | | | | | |
| Example | 2/0.75 | 195 | 180 | 45 | 45 | 45 | 45 |
| 15 | | | | | | | |
| Example | 2/0.5 | 210 | 205 | 198 | 198 | 200 | 200 |
| 16 | | | | | | | |
| Example | 2/0.25 | 223 | 218 | 218 | 215 | 215 | 215 |
| 17 | | | | | | | |
| Example | 2/0.1 | 235 | 230 | 225 | 225 | 225 | 223 |
| 18 | | | | | | | |
| Example | 2/0.01 | 235 | 233 | 230 | 228 | 228 | 225 |
| 19 | | | | | | | |

As shown in Table 15, until a mixing ratio of 2/0.5, initial foamability and foam stability did not significantly change compared to SLS, but Examples 14 and with a mixing ratio of 2/0.75 or more showed results that foam stability significantly decreased. It is considered that these mixed systems can be applied for laundry detergent for a drum washer, or automatic dishwashing detergent, etc. requiring the property that foam can be broke easily during washing while maintaining initial foam.

3) Measurement of Change in Surface Tension of a Mixed System

Results of measuring surface tension of mixed system are shown in Table 17.

TABLE 17
Measurement of change in surface tension of mixed system

| | | Concentration | | |
|---|---|---|---|---|
| | Mole ratio | 1% | 0.1% | 0.01% |
| Example | 2/1.0 | 33.96 | 34.60 | 36.36 |
| 14 | | | | |
| Example | 2/0.75 | 35.44 | 34.78 | 35.15 |
| 15 | | | | |
| Example | 2/0.5 | 35.84 | 34.85 | 34.44 |
| 16 | | | | |
| Example | 2/0.25 | 35.84 | 34.11 | 36.59 |
| 17 | | | | |
| Example | 2/0.1 | 35.82 | 32.38 | 40.00 |
| 18 | | | | |
| Example | 2/0.01 | 36.08 | 22.83 | 43.80 |
| 19 | | | | |

As shown in Table 17, Example 19 (mixing ratio of 2/0.01) showed almost the same tendency as SLS, but as the mixing ratio of the cationic compound increased, surface tension and cmc decreased. These results suggest that even with a small amount of additives, the mixed system can show superior effects to cleaning.

4) Measurement of Change in Stability to Hard Water for Mixed System

Results of measuring change in stability to hard water are shown in Table 18.

TABLE 18
Results of measuring change in stability to hard water for mixed system

| | Example 14 | Example 15 | Example 16 | Example 17 | Example 18 | Example 19 |
|---|---|---|---|---|---|---|
| | 2/1.0 | 2/0.75 | 2/0.5 | 2/0.25 | 2/0.1 | 2/0.01 |
| 1^{st} | 12.15 | 7.05 | 4.40 | 2.90 | 2.35 | 2.90 |
| 2^{nd} | 11.85 | 7.20 | 4.30 | 3.05 | 2.5 | 2.55 |
| Mean | 12.0 | 7.12 | 4.35 | 2.98 | 2.43 | 2.73 |
| Hard water | 1071 | 665 | 417 | 289 | 237 | 266 |
| concentration | | | | | | |
| [symbol] | | | | | | |

As shown in Table 18, as the mixing ratio of the cationic compound increased, stability to hard water increased, and compared to the results of Examples 8 to 13 (carbon number of alkyl group is C1), stability to hard water generally increased at the same mixing ratio. Particularly, Examples 14 to 16 with a mixing ratio of 2/0.5 or more showed remarkable stability to hard water.

2-2-4. Measurement of Changes in Physical Properties of SLS in a Mixed System of SLS and Cationic Compound of Synthesis Example 16 (R═C4/n=6)

### Examples 20 to 25

Sample mixing conditions for measuring physical properties are shown in Table 19. As results of preparing mixed systems, all the samples showed transparent phases in 1% aqueous solutions. The non-ionic surfactant, alkanolamide, was added so that its mole ratio for SLS became 1:0.001.

TABLE 19

| | Example 20 | Example 21 | Example 22 | Example 23 | Example 24 | Example 25 |
|---|---|---|---|---|---|---|
| Mole ratio | 2/1.0 | 2/0.75 | 2/0.5 | 2/0.25 | 2/0.1 | 2/0.01 |
| SLS/C₄(g) | 0.61/0.39 | 0.67/0.33 | 0.75/0.25 | 0.86/0.14 | 0.92/0.08 | 0.994/0.006 |

1) Measurement of Change in Krafft Point of Mixed System

Krafft points of Examples 20 to 25 were measured, and the results are shown in Table 20.

TABLE 20
Results of measuring change in Krafft point of mixed system

| | Example 20 | Example 21 | Example 22 | Example 23 | Example 24 | Example 25 |
|---|---|---|---|---|---|---|
| When dropping | <0 | <0 | <0 | <0 | −1 | −0.5 |
| temperatur [symbol] | | | | | | |
| When elevating | — | — | — | — | 10˜12 | 11˜13 |
| temperatur [symbol] | | | | | | |

As shown in Table 20, as in Example 25, even if only a small amount of cationic compound is mixed, the Krafft point can be lowered to 0° C. or less. This means that a mixed system maintains stability in water even at low temperature.

2) Measurement of Change in Foaming Property of Mixed System

Results of measuring foaming property are shown in Table 21.

TABLE 21
Results of measuring change in foaming property of mixed system

| | 0 min. | 1 min. | 2 min. | 3 min. | 4 min. | 5 min. |
|---|---|---|---|---|---|---|
| Example | 180 | 133 | 63 | 58 | 55 | 45 |
| 20 | | | | | | |
| Example | 178 | 113 | 73 | 43 | 38 | 35 |
| 21 | | | | | | |
| Example | 218 | 213 | 213 | 213 | 213 | 213 |
| 22 | | | | | | |
| Example | 223 | 218 | 218 | 215 | 215 | 213 |
| 23 | | | | | | |
| Example | 223 | 223 | 223 | 220 | 220 | 218 |
| 24 | | | | | | |
| Example | 235 | 230 | 230 | 230 | 225 | 225 |
| 25 | | | | | | |

As shown in Table 21, Samples of Examples 20 and 21 with a mixing ratio of the cationic compound of 2/0.75 or more showed decreased initial foamability and a phenomenon in which foam rapidly decreased after 2 minutes. Thus, it is considered that a cationic compound with a carbon number of 4 has superior capacity for lowering foam stabilty to cationic compounds with short alkyl chains.

3) Measurement of Change in Surface Tension of Mixed System

Results of measuring surface tension are shown in Table 22.

TABLE 22
Results of measuring change in surface tension of mixed system

| | Concentration | | |
|---|---|---|---|
| | 1% | 0.1% | 0.01% |
| Example 20 | 32.75 | 32.57 | 31.98 |
| Example 21 | 32.51 | 32.48 | 35.09 |
| Example 22 | 33.56 | 32.89 | 33.37 |
| Example 23 | 33.65 | 32.72 | 32.87 |
| Example 24 | 34.64 | 31.70 | 37.60 |
| Example 25 | 35.11 | 26.19 | 48.02 |

As shown in Table 22, although Example 25 with a mixing ratio of the cationic compound of 2/0.01 showed almost the same surface tension value as SLS, Examples 20 to 24 with a mixing ratio of 210.1 or more showed results that, on the basis of a 1% solution, as the mixing ratio of the cationic compound increased, the surface tension decreased. Additionally, from the result of showing a constant surface tension value to 0.01%, it can be seen that the mixed systems have a lower cmc than SLS. This indicates that the mixed system of the present invention can have superior cleaning power even at a low concentration.

4) Measurement of Change in Stability to Hard Water for Mixed System

The results of measuring stability to hard water are shown in Table 23.

TABLE 23
Measurement of change in stability to hard water for mixed system

| | Example 20 | Example 21 | Example 22 | Example 23 | Example 24 | Example 25 |
|---|---|---|---|---|---|---|
| 1^{st} | 55 | 38 | 8.45 | 3.60 | 2.95 | 3.40 |
| 2^{nd} | 58 | 38.7 | 8.75 | 3.75 | 2.90 | 3.50 |
| Mean | 56.5 | 38.35 | 8.60 | 3.68 | 2.93 | 3.45 |
| Hard water | 3610 | 2772 | 792 | 355 | 285 | 352 |
| concentrati [symbol] | | | | | | |

As shown in Table 23, although Examples 23 to 25 with mixing ratios of the cationic compound of 2/0.25 or less did not show significantly improved stability to hard water compared to SLS, Examples 20 to 22 with a mixing ratio of 2/0.5 or more showed significantly improved results. On the basis of these results, it is considered that the mixed system of the present invention can be applied to products needed superior cleaning power and phase stability under the heavier hard water conditions.

2-2-5. Measurement of Change in Physical Properties of SLS in Mixed System of SLS and Cationic Compound of Synthesis Example 17 (R═C5/n=6)

### Examples 26 to 31

Conditions for preparing samples to be used for measurement are shown in Table 24. Examples 26 and 27 with respective mixing ratios of 2/0.75 and 2/1.0 showed cloudiness and became clear under conditions of an aqueous solution of a 0.001% concentration. A non-ionic surfactant, ethoxylated fatty alcohol, was added so that its mole ratio for SLS became 1:1.

TABLE 24

| | Example 26 | Example 27 | Example 28 | Example 29 | Example 30 | Example 31 |
|---|---|---|---|---|---|---|
| Mole ratio | 2/1.0 | 2/0.75 | 2/0.5 | 2/0.25 | 2/0.1 | 2/0.01 |
| SLS/C₈(g) | 0.54/0.46 | 0.61/0.39 | 0.70/0.30 | 0.83/0.17 | 0.92/0.08 | 0.992/0.008 |
| Phase | cloudiness | cloudiness | transparent | transparent | transparent | transparent |
| stability | | | | | | |

1) Measurement of Krafft Point of Mixed System

Results of measurement are shown in Table 25. However, because Examples 26 and 27 with mixing ratios of 2/1.0 and 2/0.75 showed cloudiness at 1% aqueous solution, Krafft points were measured using 0.001% aqueous solutions. As results, Krafft points were lowered to 0° C. or less in all samples.

TABLE 25

| | Example 26 | Example 27 | Example 28 | Example 29 | Example 30 | Example 31 |
|---|---|---|---|---|---|---|
| Mole ratio | 2/1.0 | 2/0.75 | 2/0.5 | 2/0.25 | 2/0.1 | 2/0.01 |
| When dropping | <0 | <0 | <0 | <0 | −1.5 | −0.5 |
| temperature | | | | | | |
| When elevating | X | X | X | X | 12 | 12˜13 |
| temperature | | | | | | |

2) Measurement of Change in Foaming Property of Mixed System

Results of measurement are shown in Table 26. A mixed system mixing the cationic compound with a carbon number of 8 did not show a significant difference in initial foamability and foam stability from SLS, contrary to the previous experiments. However, the produced foam easily disappeared with slight stirring. Thus, it can be seen that although the produced foam is decreased easily in this mixed system, it does not disappear under the test condition after 5 minutes.

TABLE 26
Results of measuring change in foaming property of mixed system

| | Mole | 0 | 1 | 2 | 3 | 4 | 5 |
|---|---|---|---|---|---|---|---|
| | ratio | min. | min. | min. | min. | min. | min. |
| Example | 2/1.0 | 230 | 230 | 230 | 230 | 230 | 230 |
| 26 | | | | | | | |
| Example | 2/0.75 | 215 | 215 | 215 | 215 | 215 | 215 |
| 27 | | | | | | | |
| Example | 2/0.5 | 200 | 195 | 195 | 195 | 195 | 195 |
| 28 | | | | | | | |
| Example | 2/0.25 | 235 | 235 | 235 | 235 | 235 | 235 |
| 29 | | | | | | | |
| Example | 2/0.1 | 233 | 233 | 233 | 233 | 233 | 233 |
| 30 | | | | | | | |
| Example | 2/0.01 | 235 | 233 | 230 | 230 | 230 | 230 |
| 31 | | | | | | | |

3) Measurement of Change in Surface Tension of Mixed System

Results of measurement are shown in Table 27. Since surface tension t largely change between a 1% aqueous solution and a 0.01% aqueous the surface tension was measured using a 0.001% concentration of the solution. As results, as the mixing ratio of the cabonic compound d, the surface tension decreased at a 1% concentration, and surface slightly increased at a 0.001% concentration. Thus, it can be seen that of the mixed system is between 0.01˜0.001%.

TABLE 27
Results of measuring change in surface tension of mixed system

| | |
|---|---|
| Mole | concentration |

| | ratio | 1% | 0.1% | 0.01% | 0.001% |
|---|---|---|---|---|---|
| Example | 2/1.0 | 26.94 | 27.49 | 28.15 | 32.04 |
| 26 | | | | | |
| Example | 2/0.75 | 26.56 | 27.07 | 28.36 | 33.44 |
| 27 | | | | | |
| Example | 2/0.5 | 27.29 | 27.38 | 27.99 | 32.36 |
| 28 | | | | | |
| Example | 2/0.25 | 29.18 | 27.40 | 27.98 | 35.34 |
| 29 | | | | | |
| Example | 2/0.1 | 30.36 | 27.58 | 27.99 | 39.06 |
| 30 | | | | | |
| Example | 2/0.01 | 34.91 | 29.19 | 34.43 | 60.95 |
| 31 | | | | | |

4) Measurement of Change in Stability to Hard Water for Mixed System

Results of measurement are shown in Table 28. For samples showing cloudiness at 1% concentrations, stabilities to hard water were not measured. As results, at a mixing ratio of 2/0.5, stability to hard water significantly increased.

TABLE 28
Results of measuring change in stability to hard water for mixed system

| | Example 26 | Example 27 | Example 28 | Example 29 | Example 30 | Example 31 |
|---|---|---|---|---|---|---|
| Mole ratio | 2/1.0 | 2/0.75 | 2/0.5 | 2/0.25 | 2/0.1 | 2/0.01 |
| 1^{st} | cloudiness | Cloudiness | 13.0 | 3.9 | 4.15 | 3.8 |
| 2^{nd} | Cloudine [symbol] | Cloudine [symbol] | 12.5 | 3.9 | 4.15 | 3.5 |
| Mean | Cloudine [symbol] | Cloudine [symbol] | 12.75 | 3.9 | 4.15 | 3.65 |
| Hard | Cloudiness | cloudiness | 1131 | 375 | 398 | 352 |
| water | | | | | | |
| concentra [symbol] | | | | | | |

2-2-6. Measurement of Change in Physical Properties of SLS in a Mixed System of SLS and Cationic Compound of Synthesis Example 18 (R═C12/n=6)

### Examples 32 to 37

Measuring samples were prepared under conditions as shown in Table 29. Samples of Examples 32 to 34 with mixing ratios of 2/0.5 or more showed cloudiness. The sample of Example 34 became transparent at a 0.001% aqueous solution, and the others at 0.001%. The non-ionic surfactant, alkanolamide, was added so that its mole ratio for SLS became 1:0.001.

TABLE 29

| | Example 32 | Example 33 | Example 34 | Example 35 | Example 36 | Example 37 |
|---|---|---|---|---|---|---|
| SLS/ | 0.47/0.53 | 0.55/0.45 | 0.64/0.36 | 0.78/0.22 | 0.90/0.10 | 0.989/0.011 |
| Reaction | | | | | | |
| Example18 | | | | | | |
| Phase | cloudiness | cloudiness | Cloudiness | transparent | transparent | Transparent |
| stability | | | | | | |
| | 0.001% | 0.001% | 0.01% | | | |
| | transparent | transparent | Transparent | | | |

1) Measurement of Change in Krafft Point of Mixed System

Changes in Krafft point of the mixed systems of Examples 32 to 37 were measured, and the results are shown in Table 30. Examples 32 and 33 used 0.001% solutions, and Example 34 used a 0.01% solution.

TABLE 30
Results of measuring change in Krafft point of mixed system

| | Example 32 | Example 33 | Example 34 | Example 35 | Example 36 | Example 37 |
|---|---|---|---|---|---|---|
| When dropping | <0 | <0 | <0 | <0 | <0 | −1 |
| temperatur [symbol] | | | | | | |
| When elevating | — | — | — | — | — | 12˜13 |
| temperatur [symbol] | | | | | | |

As shown in Table 30, all the samples showed results that as the cationic compound was mixed, the Krafft point was lowered to 0° C. or less.

2) Measurement of Change in Foaming Property of Mixed System

Results of measuring foaming property are shown in Table 31.

TABLE 31
Results of measuring change in foaming property of mixed system

| | Mole | 0 | 1 | 2 | 3 | 4 | 5 |
|---|---|---|---|---|---|---|---|
| | ratio | min. | min. | min. | min. | min. | min. |
| Example | 2/1.0 | 20 | 0 | 0 | 0 | 0 | 0 |
| 32 | | | | | | | |
| Example | 2/0.75 | 30 | 0 | 0 | 0 | 0 | 0 |
| 33 | | | | | | | |
| Example | 2/0.5 | 193 | 190 | 190 | 190 | 190 | 190 |
| 34 | | | | | | | |
| Example | 2/0.25 | 243 | 240 | 240 | 240 | 240 | 240 |
| 35 | | | | | | | |
| Example | 2/0.1 | 243 | 240 | 238 | 238 | 238 | 238 |
| 36 | | | | | | | |
| Example | 2/0.01 | 218 | 215 | 215 | 215 | 215 | 215 |
| 37 | | | | | | | |

As shown in Table 31, Examples 32 and 33 produced little foam. From these results, it is considered that a cationic compound with a carbon number of 12 can function as an antifoaming agent.

3) Measurement of Change in Surface Tension of Mixed System

Results of measuring surface tension are shown in Table 32.

TABLE 32
Results of measuring change in surface tension of mixed system

Concentration

| | 1% | 0.1% | 0.01% | 0.001% |
|---|---|---|---|---|
| Example 32 | 24.35 | 25.79 | 30.80 | 40.31 |
| Example 33 | 24.74 | 26.86 | 31.90 | 39.93 |
| Example 34 | 25.38 | 26.41 | 32.20 | 41.45 |
| Example 35 | 26.15 | 27.76 | 33.36 | 45.65 |
| Example 36 | 27.82 | 29.76 | 35.02 | 50.05 |
| Example 37 | 36.33 | 31.59 | 48.09 | — |

As results, as the mixing ratio of the cationic compound increased, at a 1% concentration, surface tension decreased, and as the concentration decreased, surface tension slightly increased. However, at a 1% aqueous solution, as the mixing ratio of the cationic compound increased, the surface tension decreased.

4) Measurement of Change in Stability to Hard Water for Mixed System

Results of measuring stability to hard water are shown in Table 33.

TABLE 33
Results of measuring change in of mixed system

| | Example 35 | Example 36 | Example 37 |
|---|---|---|---|
| 1st | 6.10 | 3.45 | 3.35 |
| 2^{nd} | 6.10 | 3.45 | 3.50 |
| Mean | 6.10 | 3.45 | 3.43 |
| Hard water | 575 | 333 | 332 |
| concentration | | | |

As results, since Examples 32 to 34 with a mixing ratio of the cationic compound of 2/0.5 or more showed cloudiness at 1% aqueous solution, stability to hard water for these mixed systems could not be measured, and Examples 35 to 37 showed slightly improved stabilities to hard water.

3-1. Synthesis of Non-Ionic Compound Comprising Aminoxide Group in Molecule.

Desired non-ionic compounds were prepared using synthesis pathways such as in the above Equation 4 or 5.

### Synthesis Example 19

Synthesis of N-Dimethyl Lauryl Amineoxide

To 42.7 g of N-dimethyl lauryl amine (0.2 mol), 27.3 g of hydrogen peroxide (0.24 mol; 30 wt % solution) was added by droplets at room temperature, the temperature was elevated to 40° C., and then reaction was continued for 17 hours. After completion of the reaction, the product was distilled under reduced pressure and dried in vacuum to purify it.

Molecular weight: 229 g/mol

Phase: Yellow oil phase

¹H NMR(CDCl₃, δ ppm): 0.81(3H), 1.19(18H), 1.80(2H), 3.11(6H), 3.18(2H)

Mass(FAB+): m/e 230[M+H]⁺, 212

### Synthesis Example 20

Synthesis of N-(2-hydroxyethyl lauryl methyl)amine

150.22 g of 2-(methylamino)ethanol (2 mol) was dissolved in 175 g of isopropyl alcohol (IPA), and 408 g of 1-chlorodecane (2 mol) and 318 g of sodium carbonate (Na2CO3) (3 mol) were added, and then reaction was continued for 25 hours. After completion of the reaction, the product was filtered, distilled under reduced pressure, and dried in vacuum to purify it.

Molecular weight: 243 g/mol

Phase: Yellow oil

¹H NMR(CDCl₃, δ ppm): 0.86(3H), 1.26(20H),2.18(3H), 2.39(2H), 2.52(2H), 3.42(2H)

Mass(FAB+): m/e 244[M+H]⁺

### Synthesis Example 21

Synthesis of N-(2-hydroxyethyl lauryl methyl)amineoxide

To 10.5 g of methanol, 30.64 g of N-(2-hydroxyethyl lauryl methyl)amine and 21.5 g of hydrogen peroxide (0.189 mol) were added by droplets at room temperature, and temperature was elevated to reflux the mixture for 31 hours. The product was filtered, distilled under reduced pressure, and dried in vacuum to purify it.

Molecular weight: 259 g/mol

Phase: yellow solution

¹H NMR(CDCl₃, 5 ppm): 0.81(3H), 1.23(18H), 1.69(2H), 3.14(3H), 3.29(4H), 4.07(2H)

Mass (FAB+): m/e 260[M+H]⁺

### Synthesis Example 22

Synthesis of 1.6-(N,N-butylmethylamino)hexane

To 92 g of IPA, 96 G OF 2-(n,n-butylmethyl)amine (1.1 mol), 77.53 g of 1,6-dichlorohexane (0.5 mol) and 133 g of Na2CO3 were mixed, and reaction was continued at 70° C. for 36 hours. Then, the product was dried, filtered, distilled under reduced pressure, and dried in vacuum to purify it.

Molecular weight: 256 g/mol

Phase: oil phase

¹H NMR(CDCl₃, δ ppm): 0.91(6H), 1.29(8H), 1.42(8H), 2.20(6H), 2.32(8H)

Mass (FAB+): m/e 257[M+H]⁺

### Synthesis Example 23

Synthesis of 16-(N,N-butylmethyl amineoxyl)hexane

21.88 g of 1,6-(N,N-butylmethyl amino)hexane (0.086 mol) was dissolved in 14 g of methanol, and 24 g of hydrogen peroxide (0.215 mol; 30 wt % solution) were slowly added. Reaction was continued for 18 hours by reflux, and then the product was distilled under reduced pressure and dried in vacuum to purify it.

Molecular weight: 288 g/mol

Phase: yellow oil phase

¹H NMR(CDCl₃, δ ppm): 0.97(6H), 1.39(8H), 1.77(8H), 3.18(6H), 3.32(8H)

Mass (FAB+): m/e 289[M+H]⁺, 170

[Experiment 5]

3-2. Evaluation of Change in Effects of Anionic Surfactant in a Mixed System of Anionic Surfactant and Non-Ionic Compound Comprising Amineoxide Group

As an anionic surfactant for measuring physical properties, sodium lauryl sulfate (SLS; Aldrich Company reagent; purity 99% or more) was used. SLS, which has a Krafft point of 2° C. (when lowering temperature) and 14° C. (when elevating temperature) and initial foamability of 233 ml; maintains foam for 5 minutes almost constantly; and has a surface tension of 35.92 mN/m at 1%, 25.19 at 0.1%, and 57.18 at 0.01%, was used. Additionally, when measuring stability to hard water, the hard water concentration was 310 ppm.

Kinds and molecular weights of non-ionic compounds used for evaluation of physical properties are shown in Table 34.

TABLE 34
Kinds and molecular weights (g/mol) of non-ionic compound

| | Synthesis | Synthesis | Synthesis |
|---|---|---|---|
| Compound | Example | Example 21 | Example 23 |
| Molecular weight | 229 | 259 | 288 |

Glass used in the following experiment was immersed in a cleaning solution (KOH+IPA+water) for 4 hours or more, and washed with distilled water and acetone and then dried to use. For evaluation, deionized water was used.

Changes in physical properties of the anionic surfactant were measured for changes in Krafft point, initial foamability, foam stability, stability to hard water, surface tension, etc.

3-2-1. Measurement of Physical Properties of Non-Ionic Compound

1) Conditions of Measuring Sample

The non-ionic compounds of Synthesis Examples 19, 21, and 23 were respectively dissolved in 99 g of water to prepare samples of 1 wt % concentration to use for measurement. All the samples showed transparent phases.

2) Measurement of Krafft Point of Non-Ionic Compound

While cooling transparent non-ionic compound solutions of Synthesis Examples 19, 21, and 23, temperatures when the solutions became cloudy were measured (condition when lowering temperature). Also, while elevating the temperature of the clouded solution, temperatures when the solutions became transparent again were measured (condition when elevating temperature).

SLS showed cloudiness at 2-3° C. under a condition of lowering emperature, and became transparent again at 14° C. under a condition of elevating temperature. Meanwhile, Synthesis Examples 19, 21, and 23 of the present invention did not show cloudiness to 0° C. under lowering temperature drop conditions. In cases where cloudiness did not occur at 0° C., experiments under the elevation temperature condition were not conducted.

3) Measurement of Foaming Property (Initial Foamability and Foam Stability)

Foamabilities of Synthesis Examples 19, 21, and 23 were measured using a semi-micro TK method, and the results are shown in Table 35. Experiments were repeated three times, and a mean value was taken. For the experiment, a 1% aqueous solution was used.

TABLE 35

| (ml) | 0 min. | 1 min. | 2 min. | 3 min. | 4 min. | 5 min. |
|---|---|---|---|---|---|---|
| Synthesis | 210 | 55 | — | — | — | — |
| Example | | | | | | |
| Synthesis | 230 | 228 | 228 | 225 | 223 | 223 |
| Example | | | | | | |
| Synthesis | — | — | — | — | — | — |
| Example | | | | | | |

As shown in Table 35, Synthesis Example 21 showed a significant level of initial foamability and foam stability, while Synthesis Example 19 produced foam at a comparatively superior level but the foam immediately disappeared to show low stability in foam. Synthesis Example 23 did not produce foam. From these results, it is considered that Synthesis Examples 19 and 23 can be applied for a low-foaming laundry detergent, etc. requiring that produced foam should immediately be broken, and Synthesis Example 21 can be applied for a dish washing detergent requiring superior foaming property.

4) Measurement of Surface Tension

Surface tensions of non-ionic compounds of Synthesis Examples 19, 21, and 23 were measured using a tensiometer k12 from the Kruss Company with a ring method. The non-ionic compound samples of Synthesis Examples 19, 21, and 23 were prepared in solutions of concentrations of 1%, 0.1%, 0.01%, and 0.001% by weight to use for the experiment. The results are shown in Table 36.

TABLE 36
Results of measuring surface tension
of non-ionic compound (unit: mN/m)

Concentration

| | 1% | 0.1% | 0.01% | 0.001% |
|---|---|---|---|---|
| Synthesis Example | 31.94 | 29.59 | 31.67 | 53.88 |
| Synthesis Example | 28.87 | 28.36 | 26.30 | 50.34 |
| Synthesis Example | 46.51 | 56.46 | 64.05 | — |

As shown in Table 36, Synthesis Examples 19 and 21 showed comparatively low surface tensions in the measuring sample concentration range, but Synthesis Example 23 showed a high surface tension.

5) Measurement of Stability to Hard Water.

Hard water at a 10,000 ppm concentration prepared by dissolving 11.69 g of CaCl2.2H₂O in 1 L of water was used for the experiments. For the non-ionic compounds of Synthesis Examples 19, 21, and 23, 100 ml of each sample of concentration of 0.5% (weight ratio) were used to evaluate stability to hard water by adding hard water until pearl is appear. The tests were repeated by three times, and a mean value was measured. As results, since each non-ionic compound had a small negative charge, any of them was not precipitated.

3-2-2. Measurement of Changes in Physical Properties of SLS in a Mixed System of Anionic Surfactant (SLS) and Non-Ionic Compound of Synthesis Example 19

### Examples 38 to 43

Sample solutions were prepared with mole ratios of the anionic surfactant (SLS) and the non-ionic compound of Synthesis Example 19 as shown in Table 39, and all the prepared sample solutions were transparent. Cationic surfactant, quaternary ammonium salt, was added so that its mole ratio for SLS became 1:0.001

TABLE 37
Samples for measuring mixed system

| | Example | | | | | |
|---|---|---|---|---|---|---|
| | Example 38 | Example [symbol] | Example [symbol] | Example [symbol] | Example [symbol] | Example 43 |
| SLS/Non-ion | 0.56/0.44 | 0.63/0.37 | 0.72/0.28 | 0.83/0.17 | 0.93/0.07 | 0.993/0.007 |
| Phase stability | transparent | transparent | transparent | transparent | transparent | Transparent |

[Experiment 6]
Measurement of Physical Properties of Examples 38 to 43
1) Measurement of Krafft Point

Krafft points of Examples 38 to 43 (mixed systems of SLS and non-ionic compound) were measured, and the results are shown in Table 38.

TABLE 38
Measurement of Krafft point of mixed system (unit ° C.)

| | Example 38 | Example 39 | Example 40 | Example 41 | Example 42 | Example 43 |
|---|---|---|---|---|---|---|
| When dropping | 0< | 0< | 0< | 0< | 0 | 2˜3 |
| When elevating | — | — | — | — | 19 | 19˜20 |
| temperature | | | | | | |

As shown in Table 38, Examples 38 to 41 with a mixing ratio of the non-ionic additive of 1/0.25 or more showed decreased Krafft points to 0° C. or less. Examples 38 to 41 showed stable phases even at a low temperature, compared to SLS alone. In addition, the solutions of Examples 42 and 43 became opaque at 0˜3° C. under the lowering temperature, and they became transparent again at 19° C. under the elevation temperature.

2) Measurement of Foaming Property (Initial Foamability and Foam Stability)

Foaming propertys of Examples 38 to 43 were measured, and the results are shown in Table 39.

TABLE 39
Results of measuring foaming property of mixed system (unit: ml)

| | 0 min. | 1 min. | 2 min. | 3 min. | 4 min. | 5 min. |
|---|---|---|---|---|---|---|
| Example 38 | 200 | 200 | 200 | 200 | 200 | 200 |
| Example 39 | 248 | 245 | 245 | 245 | 245 | 245 |
| Example 40 | 245 | 245 | 245 | 245 | 245 | 245 |
| Example 41 | 245 | 245 | 245 | 245 | 245 | 245 |
| Example 42 | 250 | 248 | 248 | 245 | 245 | 245 |
| Example 43 | 250 | 250 | 250 | 250 | 250 | 250 |

As shown in Table 39, as the mixing ratio of the non-ionic compound is lower, like Example 43, initial foamability and foam stability tended to be similar to SLS. Also, although as the mixing ratio of the non-ionic additive decreases, initial foamability increases, once the formed foam is significantly stably maintained, it shows superior foam stability. From these results, it is considered that these mixed systems can be applied for products requiring sufficient foaming such as shampoo or body cleanser, etc.

3) Measurement of Surface Tension

The results of measuring surface tension are show in Table 40.

TABLE 40
Results of measuring changes in surface tension
of mixed system (room temperature)

Concentration

| | 1% | 0.1% | 0.01% | 0.001% |
|---|---|---|---|---|
| Example 38 | 26.13 | 23.36 | 23.46 | 41.90 |
| Example 39 | 26.10 | 23.34 | 23.56 | 43.33 |
| Example 40 | 26.56 | 23.51 | 23.80 | 46.79 |
| Example 41 | 27.13 | 23.33 | 26.26 | 48.25 |
| Example 42 | 28.37 | 23.11 | 29.02 | 52.65 |
| Example 43 | 31.06 | 24.05 | 34.05 | 60.81 |

As shown in Table 40, Example 43 showed a surface tension value almost the same as SLS, but as the mixing ratio of the non-ionic compound increased, the surface tension value tended to decrease. The results that surface tension decreases and is maintained constantly at a low concentration mean that the cmc is low, which indicates that even a small amount can show superior cleaning power.

4) Measurement of Change in Stability to Hard Water for Mixed System

Results of measuring stability to hard water for mixed system are shown in Table 41.

TABLE 41
Measurement of change in stability to hard water for mixed system

| | Example 38 | Example 39 | Example 40 | Example 41 | Example 42 | Example 43 |
|---|---|---|---|---|---|---|
| 1^{st} | 6.10 | 6.70 | 6.55 | 3.60 | 2.90 | 3.15 |
| 2^{nd} | 6.10 | 6.60 | 7.20 | 5.15 | 2.95 | 3.35 |
| Mean | 6.10 | 6.65 | 6.88 | 4.38 | 2.93 | 3.25 |
| Hard water | 575 | 624 | 644 | 420 | 285 | 315 |
| concentration | | | | | | |
| (ppm) | | | | | | |

As shown in Table 41, as the mixing ratio of the non-ionic compound increased, the added amount of hard water increased. The mixed system of the SLS and the non-ionic compound showed stability to hard water superior by about twice compared to SLS alone.

3-2-3. Measurement of Changes in Physical Properties of SLS in a Mixed System of SLS and Non-Ionic Compound of Synthesis Example 23.

### Examples 44 to 49

Sample solutions were prepared with mole ratios of the anionic surfactant (SLS) and the non-ionic compound of Synthesis Example 23 as shown in Table 35, and all the prepared solutions were transparent. Cationic surfactant quaternary ammonium salt was added so that its mole ratio for SLS became 1:0.001.

TABLE 42
Samples for measuring mixed system

| | Example | | | | | |
|---|---|---|---|---|---|---|
| | Example 44 | Example 45 | Example 46 | Example 47 | Example 48 | Example 49 |
| SLS/Non-ion | 0.67/0.33 | 0.73/0.27 | 0.8/0.2 | 0.89/0.11 | 0.95/0.05 | 0.995/0.005 |
| Phase stability | transparent | transparent | transparent | transparent | transparent | Transparent |

[Experiment 7]
Measurement of Physical Properties of Examples 44 to 49
1) Measurement of Krafft Point

Krafft point of a mixed system of the SLS and the non-ionic compound was measured, and the results are shown in Table 43.

TABLE 43
Measurement of Krafft point of mixed system (unit ° C.)

| | Example | | | | | |
|---|---|---|---|---|---|---|
| | Example 44 | Example 45 | Example 46 | Example 47 | Example 48 | Example 49 |
| When dropping | 0< | 0< | 0< | 0< | 0 | 1 |
| When elevating | — | — | — | — | 11˜12 | 13 |
| temperature | | | | | | |

As shown in Table 43, Examples 44 to 47 with mixing ratios of the non-ionic additive of 1/0.25 or more showed decreased Krafft points to 0° C. or lower. The solutions of Examples 48 and 49 became opaque at 0˜1° C. under the lowering temperature, and they became transparent again at 11˜13° C. under the elevation temperature. It can be seen that this mixed system has stability to low temperature superior to SLS.

2) Measurement of Foaming Property (Initial Foamability and Foam Stability)

Results of measuring foaming property of Examples 44 to 49 are shown in Table 44.

TABLE 44
Results of measuring foaming stabilty of mixed system (unit: ml)

| | 0 min. | 1 min. | 2 min. | 3 min. | 4 min. | 5 min. |
|---|---|---|---|---|---|---|
| Example 44 | 183 | 160 | 143 | 125 | 113 | 105 |
| Example 45 | 190 | 160 | 153 | 145 | 145 | 138 |
| Example 46 | 200 | 190 | 183 | 178 | 175 | 173 |
| Example 47 | 200 | 200 | 198 | 195 | 195 | 195 |
| Example 48 | 223 | 218 | 213 | 210 | 203 | 198 |
| Example 49 | 233 | 228 | 228 | 225 | 225 | 223 |

As shown in Table 44, as the mixing ratio of the non-ionic compound became lower, initial foamability and foam stability tended to be similar to SLS. Also, as the mixing ratio of the non-ionic compound decreased, the initial foamability increased and the foam gradually decreased as time passed. Such physical properties can be applied for a dish washig detergent or laundry detergent requiring superior rinsing.

3) Measurement of Surface Tension

Results of measuring surface tension are shown in Table 45.

TABLE 45
Results of measuring change in surface tension
of mixed system (room temperature)

Concentration

| | 1% | 0.1% | 0.01% | 0.001% |
|---|---|---|---|---|
| Example 44 | 34.31 | 31.64 | 39.67 | 61.51 |
| Example 45 | 35.15 | 31.72 | 39.08 | 60.73 |
| Example 46 | 33.74 | 32.16 | 41.13 | 61.68 |
| Example 47 | 36.18 | 32.17 | 43.40 | 62.94 |
| Example 48 | 36.55 | 31.87 | 47.51 | 64.63 |
| Example 49 | 37.07 | 33.48 | 56.61 | 64.20 |

As shown in Table 45, Examples 48 and 49 showed surface tension values almost the same as SLS, but as the mixing ratio of the non-ionic compound increased, the surface tension decreased. The results that surface tension decreases and is maintained constantly even at a lower concentration means that the cmc is low, which indicates that even with only a small amount can show superior effects to cleaning.

4) Measurement of Stability to Hard Water for Mixed System

Results of measuring stability to hard water for a mixed system are shown in Table 46.

TABLE 46
Measurement of change in stability
to hard water for mixed system

Concentration

| | 1% | 0.1% | 0.01% | 0.001% |
|---|---|---|---|---|
| Example 44 | 34.31 | 31.64 | 39.67 | 61.51 |
| Example 45 | 35.15 | 31.72 | 39.08 | 60.73 |
| Example 46 | 33.74 | 32.16 | 41.13 | 61.68 |
| Example 47 | 36.18 | 32.17 | 43.40 | 62.94 |
| Example 48 | 36.55 | 31.87 | 47.51 | 64.63 |
| Example 49 | 37.07 | 33.48 | 56.61 | 64.20 |

As results, as the mixing ratio of non-ionic compound increased, stability to hard water increased by about twice as much.

As explained, the mixed surfactant system of the present invention comprises a compound comprising at least one kind of non-ionic group or cationic group to increase cleaning power of an anionic surfactant, control initial foamability and foam stability, and increase stability to hard water and lower surface tension and cmc, and thus it is very effective for solid, liquid, gel, and paste types detergents, etc. such as laundry detergent, shampoo, rinse, dish washing detergent, hair-dye, fabric softener, soap, etc.

1. A surfactant system comprising
a) an anionic surfactant;
b) a cationic compound represented by the following Chemical Formula 1; and
c) a non-ionic surfactant: 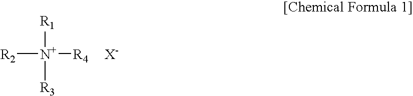
(wherein
R₁, R₂, R₃, and R₄ are independently or simultaneously C1˜C20 saturated or unsaturated chain groups, benzyl groups, hydroxy ethyl groups, or hydroxy ethyl groups to which 1 to 20 ethylene oxide or propylene oxide groups are attached; and X is a halogen atom, a sulfate group, or an acetate group).

2. The surfactant system according to claim 1, wherein the mixing ratio of the a) anionic surfactant, the b) cationic compound, and the c) non-ionic surfactant is 1:0.001:0.001˜1:1:1 by mole ratio.

3. The surfactant system according to claim 1, wherein the cationic compound is prepared by a process comprising the step of heat-reacting a tertiary amine with an alkyl halide under an alkaline condition to cause quaternarization.

4. A surfactant system comprising
a) an anionic surfactant; and
b) a cationic compound represented by the following Chemical Formula 2: 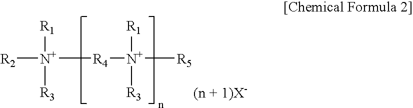
(wherein
R₁, R₂, R₃, and R₅ are independently or simultaneously C1˜C20 saturated or unsaturated chain groups, benzyl groups, hydroxy ethyl groups, or hydroxy ethyl groups to which 1 to 20 ethylene oxide or propylene oxide groups are attached; R₄ is a C1˜C20 alkyl group, an alkyl group to which 1 to 10 ethylene oxide or propylene oxide groups are attached, or an alkyl group to which 1 or more hydroxyl groups are bound; n is an integer of 1 to 20; and X is a halogen atom, a sulfate group, or an acetate group.)

5. The surfactant system according to claim 4, wherein the mixing ratio of the a) anionic surfactant and the b) cationic compound is 1:0.0001˜1:0.5 by mole ratio.

6. The surfactant system according to claim 4, wherein the cationic compound is selected from a group consisting of
1,6-[2-(N-dimethylamino)ethanol]hexane,
1,6-[2-(N,N-ethylmethylamino)ethanol]hexane,
1,6-[2-(N,N-butylmethylamino)ethanol]hexane,
1,6-[2-(N,N-methyloctylamino)ethanol]hexane,
1,6-[2-(N,N-dodecylmethylamino)ethanol]hexane,
1,8-[2-(N-dimethylamino)ethanol]octane,
1,8-[2-(N,N-ethylmethylamino)ethanol]octane,
1,8-[2-(N,N-butylmethylamino)ethanol]octane,
1,8-[2-(N,N-methyloctylamino)ethanol]octane,
1,8-[2-(N,N-dodecylmethylamino)ethanol]octane,
1,6-[2-(N-dimethylamino)ethanol(EO)₂]hexane,
1,6-[2-(N,N-ethylmethylamino)ethanol(EO)₂]hexane,
1,6-[2-(N,N-butylmethylamino)ethanol(EO)₂hexane,
1,6-[2-(N,N-methyloctylamino)ethanol(EO)₂]hexane,
1,6-[2-(N,N-dodecylmethylamino)ethanol(EO)₂]hexane,
1,6-[2-(N-dimethylamino)ethanol(EO)₄]hexane,
1,6-[2-(N,N-ethylmethylamino)ethanol(EO)₄]hexane,
1,6-[2-(N,N-butylmethylamino)ethanol(EO)₄]hexane,
1,6-[2-(N,N-methyloctylamino)ethanol(EO)₄]hexane,
1,6-[2-(N,N-dodecylmethylamino)ethanol(EO)₄]hexane,
1,8-[2-(N-dimethylamino)ethanol(EO)₂]octane,
1,7-[2-(N,N-ethylmethylamino)ethanol(EO)₂]octane,
1,8-[2-(N,N-butylmethylamino)ethanol(EO)₂] octane,
1,8-[2-(N,N-methyloctylamino)ethanol(EO)₂]octane,
1,8-[2-(N,N-dodecylmethylamino)ethanol(EO)₂]octane,
1,8-[2-(N-dimethylamino)ethanol(EO)₄]octane,
1,8-[2-(N,N-ethylmethylamino)ethanol(EO)₄]octane,
1,8-[2-(N,N-butylmethylamino)ethanol(EO)₄]octane,
1,8-[2-(N,N-methyloctylamino)ethanol(EO)₄]octane,
1,8-[2-(N,N-dodecylmethylamino)ethanol(EO)₄]octane,
1,6-[2-(N-dimethylamino)ethanol(PO)₂]hexane,
1,6-[2-(N,N-ethylmethylamino)ethanol(PO)₂]hexane,
1,6-[2-(N,N-butylmethylamino)ethanol(PO)₂]hexane,
1,6-[2-(N,N-methyloctylamino)ethanol(PO)₂]hexane,
1,6-[2-(N,N-dodecylmethylamino)ethanol(PO)₂]hexane,
1,6-[2-(N-dimethylamino)ethanol(PO)₄]hexane,
1,6-[2-(N,N-ethylmethylamino)ethanol(PO)₄]hexane,
1,6-[2-(N,N-butylmethylamino)ethanol(PO)₄]hexane,
1,6-[2-(N,N-butylmethylamino)ethanol(PO)₄]hexane,
1,6-[2-(N,N-methyloctylamino)ethanol(PO)₄]hexane,
1,6-[2-(N,N-dodecylmethylamino)ethanol(PO)₄]hexane,
1,8-[2-(N-dimethylamino)ethanol(PO)₂]octane,
1,8-[2-(N,N-ethylmethylamino)ethanol(PO)₂]octane,
1,8-[2-(N,N-butylmethylamino)ethanol(PO)₂]octane,
1,8-[2-(N,N-methyloctylamino)ethanol(PO)₂]octane,
1,8-[2-(N,N-dodecylmethylamino)ethanol(PO)₂]octane,
1,8-[2-(N-dimethylamino)ethanol(PO)₄]octane,
1,8-[2-(N,N-ethylmethylamino)ethanol(PO)₄]octane,
1,8-[2-(N,N-butylmethylamino)ethanol(PO)₄]octane,
1,8-[2-(N,N-methyloctylamino)ethanol(PO)₄]octane,
1,8-[2-(N,N-dodecylmethylamino)ethanol(PO)₄]octane, and a mixture thereof.

7. The surfactant system according to claim 4, wherein the cationic compound comprises one or more kinds of quaternary ammonium salts comprising one or more kinds of hydroxy ethyl groups in a molecule, and one or more kinds of quaternary ammonium salts comprising a functional group in which 2 to 10 moles of ethylene oxide (EO) or propylene oxide (PO) groups are added to the hydroxyl group.

8. The surfactant system according to claim 4, wherein the cationic compound is prepared by a process comprising the steps of
i) reacting a secondary amine with an alkyl halide under an alkaline condition to prepare a tertiary amine; and
ii) binding a linker represented by the following Chemical Formula 3 to the tertiary amine obtained in step i) to cause quaternarization:
X+CH₂)n-X [Chemical Formula 3]
(wherein n is an integer of 1 to 20; and X is a halogen atom, a sulfate group, or an acetate group.).

9. The surfactant system according to claim 8, wherein the cationic compound is prepared by a process comprising the steps of
i) binding the linker of Chemical Formula 3 with a secondary amine under an alkaline condition to prepare a tertiary amine; and
ii) binding an alkyl halide to the tertiary amine obtained in step i) to cause quaternarization.

10. The surfactant system according to claim 1, wherein the anionic surfactant is selected from a group consisting of sodium lauryl sulfonate (SLS), sodium lauryl ether sulfonate (SLES), a linear alkyl benzene sulfonate (LAS), monoalkyl phosphate (MAP), acyl isethionate (SCI), an alkyl glyceryl ether sulfonate (AGES), acylglutamate, acyltaurate, a fatty acid metal salt, and a mixture thereof.

11. The surfactant system according to claim 1, wherein the non-ionic surfactant is selected from a group consisting of an ethoxylated fatty alcohol, an ethoxylated fatty acid, an ethoxylated alkyl phenol, an alkanolamide (fatty acid alkanolamide), an ethoxylated fatty acid alkanolamide, a fatty amine oxide, a fatty amido amine oxide, a glyceryl fatty acid ester, sorbitan, an ethoxylated sorbitan ester, an alkyl poly glycoside, an ethylene/propylene oxide copolymer, an ethoxylated-propoxylated fatty alcohol, and a mixture thereof.

12. A surfactant system comprising
a) an anionic surfactant; and
b) a compound represented by the following Chemical Formula 4: 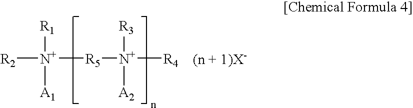
(wherein
R₁, R₂, R₃, and R₄ are independently or simultaneously C1˜20 saturated or unsaturated chain groups, benzyl groups, hydroxy ethyl groups, or hydroxy ethyl groups to which 1 to 20 ethylene oxide or propylene oxide groups are added; R₅ is a C1˜20 alkyl group, an alkyl group to which 1 to 20 ethylene oxide or propylene oxide groups are added, an alkyl group to which one or more hydroxyl groups are bound, an alkyl group comprising at least one double bond, or an alkyl group comprising at least one ether group; A₁ and A₂ are independently or simultaneously C1˜20 saturated or unsaturated chain groups, benzyl groups, hydroxy ethyl groups, hydroxy ethyl groups to which 1 to 20 ethylene oxide or propylene oxide groups are added, or oxygen anions (O—); n is an integer of 0 to 20; X is a halogen atom, a sulfate group, a methyl sulfate group, or an acetate group.).

13. The surfactant system according to claim 12, wherein the mixing ratio of the a) anionic surfactant and the b) compound of Chemical Formula 4 is 1:0.0001˜1:1.0 by mole ratio.

14. A surfactant system comprising
a) an anionic surfactant;
b) a compound represented by the following Chemical Formula 4; and
c) a non-ionic surfactant, a cationic surfactant or a mixture thereof: 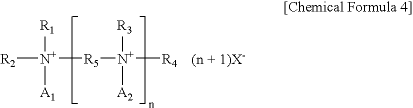
(wherein
R₁, R₂, R₃, and R₄ are independently or simultaneously C1˜20 saturated or unsaturated chain groups, benzyl groups, hydroxy ethyl groups, or hydroxy ethyl groups to which 1 to 20 ethylene oxide or propylene oxide groups are added; R₅ is a C1˜20 alkyl group, an alkyl group to which 1 to 20 ethylene oxide or propylene oxide groups are added, an alkyl group to which one or more hydroxyl groups are bound, an alkyl group comprising at least one double bond, or an alkyl group comprising at least one ether group; A₁ and A₂ are independently or simultaneously C1˜20 saturated or unsaturated chain groups, benzyl groups, hydroxy ethyl groups, hydroxy ethyl groups to which 1 to 20 ethylene oxide or propylene oxide groups are added, or oxygen anions (O—); n is an integer of 0 to 20; and X is a halogen atom, a sulfate group, a methylsulfate group, or an acetate group.).

15. The surfactant system according to claim 14, wherein the mixing ratio of the a) anionic surfactant, the b) compound of Chemical Formula 4 and the c) non-ionic surfactant is 1:0.0001:0.000 1˜1:1.0:0.5 by mole ratio.

16. The surfactant system according to claim 14, wherein the mixing ratio of the a) anionic surfactant, the b) compound of Chemical Formula 4, and the c) cationic surfactant is 1:0.0001:0.0001˜1:1.0:0.5.

17. The surfactant system according to claim 14, wherein the mixing ratio of the a) anionic surfactant, the b) compound of Chemical Formula 4, and the c) mixture of non-ionic surfactant and cationic surfactant is 1:0.0001:0.0001˜1:1.0:0.5.

18. The surfactant system according to claim 12, wherein the compound of Chemical Formula 4 is a non-ionic compound selected from a group consisting of
N,N,N-dimethyllauryl amine oxide;
N,N,N-ethylmethyllauryl amine oxide;
N,N,N-dimethyldodecyl amine oxide;
N,N,N-butylmethyllauryl amine oxide;
N,N,N-dimethylhexadecyl amine oxide;
N,N,N-dibutyllauryl amine oxide;
N,N,N-(2-hydroxyethyllaurylmethyl)amine oxide;
N,N,N-(di-2-hydroxyethyllauryl)amine oxide;
N,N,N-(2-hydroxyethyllaurylbutyl)amine oxide;
N,N,N-(2-hydroxy(EO)₅ethyllaurylmethyl)amine oxide;
N,N,N-(2-hydroxyethyl(PO)₅ 1 aurylmethyl)amine oxide;
N,N,N-(2-hydroxyethyl(EO)₅(PO)₅laurylmethyl)amine oxide;
N,N,N-(2-hydrxoyethyl(EO)₁₀laurylmethyl)amine oxide;
N,N,N-(2-hydrxoyethyl(EO)₁₅laurylmethyl)amine oxide;
1,6-(N,N-butylmethylaminooctyl)hexane;
1,6-(N,N-butylmethylaminooctyl)dipropylether;
1,6-(N,N-butylmethylaminooctyl)-3-hydroxyhexane;
1,6-(N,N-butylmethylaminooctyl) butane;
1,6-(N,N-butylmethylaminooctyl) octane;
1,6-(N,N-butylmethyl amin oxyl)-2-hydroxypropane;
1,6-[2-(N-methylaminooctyl)ethanol]hexane;
1,6-[2-(N-methylaminooctyl)ethanol(EO)₅]hexane;
1,6-[2-(N-methylaminooctyl)ethanol(PO)₅]hexane;
1,6-[2-(N-methylaminooctyl)ethanol(EO)₅(PO)₅]hexane;
1,6-[2-(N-methylaminooctyl)ethanol (EO)₁₀]hexane;
1,6-[2-(N-methylaminooctyl)ethanol]dipropylether;
1,6-[2-(N-methylaminooctyl)ethanol]-2-hydroxypropane;
1,6-[2-(N-methylaminooctyl)Ethanol]butane;
1,6-[2-(N-methylaminooctyl)ethanol]octane; and a mixture thereof.

19. The surfactant system according to claim 18, wherein the non-ionic compound is prepared by reacting a tertiary amine with peroxide.

20. The surfactant system according to claim 18, wherein the non-ionic compound is prepared by binding a linker represented by the following Chemical Formula 5 to a secondary amine to obtain a tertiary amine, and then reacting the tertiary amine with hydrogen peroxide: 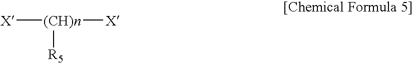
(wherein n is an integer of 1 to 20; X is a halogen atom; and R₅ is hydrogen or an alkyl or allyl group comprising at least one double bond, a hydroxyl group, or an ether group.).

21. The surfactant system according to claim 12, wherein the compound of Chemical Formula 4 is a cationic compound selected from a group consisting of dimethyloctylethoxy ammonium, dimethyl decyl ethoxy ammonium, dimethyl lauryl ethoxy ammonium, dimethyloctylethanol (EO)₅ ammonium, dimethyldecylethanol (EO)₅ ammonium, dimethyllaurylethanol (EO)₅ ammonium, dimethyloctylethanol (EO)₁₀ ammonium, dimethyldecylethanol (EO)₁₀ ammonium, dimethyllaurylethanol (EO)₁₀ ammonium, dimethyloctylethanol (EO)₁₅ ammonium, dimethyldecylethanol (EO)₁₅ ammonium, dimethyllaurylethanol(EO)₁₅ ammonium, trimethyloctyl ammonium, tridecyllauryl ammonium, trimethyllauryl ammonium,
1,6-[2-(N-dimethylamino)ethanol]hexane,
1,6-[2-(N,N-ethylmethylamino)ethanol]hexane,
1,6-[2-(N,N-butylmethylamino)ethanol]hexane,
1,6-[2-(N,N-methyloctylamino)ethanol]hexane,
1,6-[2-(N,N-dodecylmethylamino)ethanol]hexane,
1,8-[2-(N-dimethylamino)ethanol]octane,
1,8-[2-(N,N-ethylmethylamino)ethanol]octane,
1,8-[2-(N,N-butylmethylamino)ethanol]octane,
1,8-[2-(N,N-methyloctylamino)ethanol]octane,
1,8-[2-(N,N-dodecylmethylamino)ethanol]octane,
1,6-[2-(N,-dimethylamino)ethanol(EO)₂]hexane,
1,6-[2-(N,N-ethylmethylamino)ethanol(EO)₂]hexane,
1,6-[2-(N,N-butylmethylamino)ethanol(EO)₂]hexane,
1,6-[2-(N,N-methyloctylamino)ethanol(EO)₂]hexane,
1,6-[2-(N,N-dodecylmethylamino)ethanol(EO)₂]hexane,
1,6-[2-(N-dimethylamino)ethanol(EO)₄]hexane,
1,6-[2-(N-dimethylamino)ethanol(EO)₄]hexane,
1,6-[2-(N,N-ethylmethylamino)ethanol(EO)₄]hexane,
1,6-[2-(N,N-butylmethylamino)ethanol(EO)₄]hexane,
1,6-[2-(N,N-methyloctylamino)ethanol(EO)₄]hexane,
1,6-[2-(N,N-dodecylmethylamino)ethanol(EO)₄]hexane,
1,8-[2-(N-dimethylamino)ethanol(EO)₂]octane,
1,8-[2-(N,N-ethylmethylamino)ethanol(EO)₂]octane,
1,8-[2-(N,N-butylmethylamino)ethanol(EO)₂]octane,
1,8-[2-(N,N-methyloctylamino)ethanol(EO)₂]octane,
1,8-[2-(N,N-ethylmethylamino)ethanol(EO)₄]octane,
1,8-[p2-(N,N-butylmethylamino)ethanol(EO)₄]octane,
1,8-[2-(N,N-methyloctylamino)ethanol(EO)₄]octane,
1,8-[2-(N,N-dodecylmethylamino)ethanol(EO)₄]octane,
1,6-[2-(N-dimethylamino)ethanol(PO)₂]hexane,
1,6-[2-(N,N-ethylmethylamino)ethanol(PO)₂]hexane,
1,6-[2-(N,N-butylmethylamino)ethanol(PO)₂]hexane,
1,6-[2-(N,N-methyloctylamino)ethanol(PO)₂]hexane,
1,6-[2-(N,N-dodecylmethylamino)ethanol(PO)₂]hexane,
1,6-[2-(N-dimethylamino)ethanol(PO)₄]hexane,
1,6-[2-(N,N-ethylmethylamino)ethanol(PO)₄]hexane,
1,6-[2-(N,N-butylmethylamino)ethanol(PO)₄]hexane,
1,6-[2-(N,N-methyloctylamino)ethanol(PO)₄]hexane,
1,6-[2-(N,N-dodecylmethylamino)ethanol(PO)₄]hexane,
1,8-[2-(N-dimethylamino)ethanol(PO)₂]octane,
1,8-[2-(N,N-butylmethylamino)ethanol(PO)₂]octane,
1,8-[2-(N,N-methyloctylamino)ethanol(PO)₂]octane,
1,8-[2-(N,N-dodecylmethylamino)ethanol(PO)₂]octane,
1,8-[2-(N-dimethylamino)ethanol(PO)₄]octane,
1,8-[2-(N,N-ethylmethylamino)ethanol(PO)₄]octane,
1,8-[2-(N,N-butylmethylamino)ethanol(PO)₄]octane,
1,8-[2-(N,N-methyloctylamino)ethanol(PO)₄]octane,
1,8-[2-(N,N-dodecylmethylamino)ethanol(PO)₄]octane, and a mixture thereof.

22. The surfactant system according to claim 21, wherein the cationic compound is prepared by a process comprising the steps of
i) reacting a secondary amine with a compound represented by the following Chemical Formula 5 under an alkaline condition to prepare a tertiary amine; and
ii) binding the tertiary amine with a compound comprising a C1˜20 saturated or unsaturated chain group, a benzyl group, a hydroxy ethyl group, or a hydroxy ethyl group to which 1 to 20 ethylene oxide or propylene oxide groups are added to cause quaternarization: 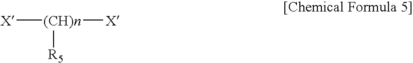
(wherein n is an integer of 1 to 20; X is a halogen atom; R₅ is hydrogen, or an alkyl or allyl group comprising at least one double bond, a hydroxyl group, or an ether group).

23. The surfactant system according to claim 21, wherein the cationic compound is prepared by a process comprising the steps of
i) binding a compound comprising C1˜20 saturated or unsaturated chain groups, benzyl groups, hydroxy ethyl groups, or hydroxy ethyl groups to which 1 to 20 ethylene oxide or propylene oxide groups are added to a secondary amine to prepare a tertiary amine; and
ii) binding the tertiary amine with the compound of Chemical Formula 4 to cause quaternarization.

24. The surfactant system according to claim 12, wherein the anionic surfactant is selected from a group consisting of sodium lauryl sulfonate (SLS), sodium lauryl ether sulfonate (SLES), a linear alkyl benzene sulfonate (LAS), monoalkyl phosphate (MAP), acyl isethionate (SCI), an alkyl glyceryl ether sulfonate (AGES), acylglutamate, acyltaurate, a fatty acid metal salt, and a mixture thereof.

25. The surfactant system according to claim 14, wherein the non-ionic surfactant is selected from a group consisting of alcohol alkoxylate, alkylphenol ethoxylate, alkylpolyglycosides, amine oxide, alkanolamide, and a mixture thereof.

26. The surfactant system according to claim 14, wherein the cationic surfactant is selected from a group consisting of a compound of an amine salt form, a compound comprising quaternary ammonium, a monoalkyl dimethyl amine derivative, a dialkyl monomethyl amine derivative, an imidazoline derivative, a quaternary ammonium compound of a Geminic form, a cationic surfactant of an oligomeric quaternary ammonium form, and a mixture thereof.

27. A detergent composition of solid, liquid, gel, or paste types comprising the surfactant system of claim 1.

28. A detergent composition of solid, liquid, gel, or paste types comprising the surfactant system of claim 4.

29. A detergent composition of solid, liquid, gel, or paste types comprising the surfactant system of claim 12.

30. The surfactant system according to claim 4, wherein the anionic surfactant is selected from a group consisting of sodium lauryl sulfonate (SLS), sodium lauryl ether sulfonate (SLES), a linear alkyl benzene sulfonate (LAS), monoalkyl phosphate (MAP), acyl isethionate (SCI), an alkyl glyceryl ether sulfonate (AGES), acylglutamate, acyltaurate, a fatty acid metal salt, and a mixture thereof.

31. The surfactant system according to claim 14, wherein the compound of Chemical Formula 4 is a non-ionic compound selected from a group consisting of
N,N,N-dimethyllauryl amine oxide;
N,N,N-ethylmethyllauryl amine oxide;
N,N,N-dimethyldodecyl amine oxide;
N,N,N-butylmethyllauryl amine oxide;
N,N,N-dimethylhexadecyl amine oxide;
N,N,N-dibutyllauryl amine oxide;
N,N,N-(2-hydroxyethyllaurylmethyl)amine oxide;
N,N,N-(di-2-hydroxyethyllauryl)amine oxide;
N,N,N-(2-hydroxyethyllaurylbutyl)amine oxide;
N,N,N-(2-hydroxy(EO)₅ethyllaurylmethyl)amine oxide;
N,N,N-(2-hydroxyethyl(PO)₅laurylmethyl)amine oxide;
N,N,N-(2-hydroxyethyl(EO)₅(PO)₅laurylmethyl)amine oxide;
N,N,N-(2-hydrxoyethyl(EO)₁₀laurylmethyl)amine oxide;
N,N,N-(2-hydrxoyethyl(EO)₁₅laurylmethyl)amine oxide;
1,6-(N,N-butylmethylaminooctyl)hexane;
1,6-(N,N-butylmethylaminooctyl)dipropylether;
1,6-(N,N-butylmethylaminooctyl)-3-hydroxyhexane;
1,6-(N,N-butylmethylaminooctyl) butane;
1,6-(N,N-butylmethylaminooctyl) octane;
1,6-(N,N-butylmethyl amin oxyl)-2-hydroxypropane;
1,6-[2-(N-methylaminooctyl)ethanol]hexane;
1,6-[2-(N-methylaminooctyl)ethanol(EO)₅]hexane;
1,6-[2-(N-methylaminooctyl)ethanol(PO)₅]hexane;
1,6-[2-(N-methylaminooctyl)ethanol(EO)₅(PO)₅]hexane;
1,6-[2-(N-methylaminooctyl)ethanol (EO)₁₀]hexane;
1,6-[2-(N-methylaminooctyl)ethanol]dipropylether;
1,6-[2-(N-methylaminooctyl)ethanol]-2-hydroxypropane;
1,6-[2-(N-methylaminooctyl)Ethanol]butane;
1,6-[2-(N-methylaminooctyl)ethanol]octane; and a mixture thereof.

32. The surfactant system according to claim 14, wherein the compound of Chemical Formula 4 is a cationic compound selected from a group consisting of dimethyloctylethoxy ammonium, dimethyl decyl ethoxy ammonium, dimethyl lauryl ethoxy ammonium, dimethyloctylethanol (EO)₅ ammonium, dimethyldecylethanol (EO)₅ ammonium, dimethyllaurylethanol (EO)₅ ammonium, dimethyloctylethanol (EO)₁₀ ammonium, dimethyldecylethanol (EO)₁₀ ammonium, dimethyllaurylethanol (EO)₁₀ ammonium, dimethyloctylethanol (EO)₁₅ ammonium, dimethyldecylethanol (EO)₁₅ ammonium, dimethyllaurylethanol(EO)₁₅ ammonium, trimethyloctyl ammonium, tridecyllauryl ammonium, trimethyllauryl ammonium,
1,6-[2-(N-dimethylamino)ethanol]hexane,
1,6-[2-(N,N-ethylmethylamino)ethanol]hexane,
1,6-[2-(N,N-butylmethylamino)ethanol]hexane,
1,6-[2-(N,N-methyloctylamino)ethanol]hexane,
1,6-[2-(N,N-dodecylmethylamino)ethanol]hexane,
1,8-[2-(N-dimethylamino)ethanol]octane,
1,8-[2-(N,N-ethylmethylamino)ethanol]octane,
1,8-[2-(N,N-butylmethylamino)ethanol]octane,
1,8-[2-(N,N-methyloctylamino)ethanol]octane,
1,8-[2-(N,N-dodecylmethylamino)ethanol]octane,
1,6-[2-(N,-dimethylamino)ethanol(EO)₂]hexane,
1,6-[2-(N,N-ethylmethylamino)ethanol(EO)₂]hexane,
1,6-[2-(N,N-butylmethylamino)ethanol(EO)₂]hexane,
1,6-[2-(N,N-methyloctylamino)ethanol(EO)₂]hexane,
1,6-[2-(N,N-dodecylmethylamino)ethanol(EO)₂]hexane,
1,6-[2-(N-dimethylamino)ethanol(EO)₄]hexane,
1,6-[2-(N-dimethylamino)ethanol(EO)₄]hexane,
1,6-[2-(N,N-ethylmethylamino)ethanol(EO)₄]hexane,
1,6-[2-(N,N-butylmethylamino)ethanol(EO)₄]hexane,
1,6-[2-(N,N-methyloctylamino)ethanol(EO)₄]hexane,
1,6-[2-(N,N-dodecylmethylamino)ethanol(EO)₄]hexane,
1,8-[2-(N-dimethylamino)ethanol(EO)₂]octane,
1,8-[2-(N,N-ethylmethylamino)ethanol(EO)₂]octane,
1,8-[2-(N,N-butylmethylamino)ethanol(EO)₂]octane,
1,8-[2-(N,N-methyloctylamino)ethanol(EO)₂]octane,
1,8-[2-(N,N-ethylmethylamino)ethanol(EO)₄]octane,
1,8-[p2-(N,N-butylmethylamino)ethanol(EO)₄]octane,
1,8-[2-(N,N-methyloctylamino)ethanol(EO)₄]octane,
1,8-[2-(N,N-dodecylmethylamino)ethanol(EO)₄]octane,
1,6-[2-(N-dimethylamino)ethanol(PO)₂]hexane,
1,6-[2-(N,N-ethylmethylamino)ethanol(PO)₂]hexane,
1,6-[2-(N,N-butylmethylamino)ethanol(PO)₂]hexane,
1,6-[2-(N,N-methyloctylamino)ethanol(PO)₂]hexane,
1,6-[2-(N,N-dodecylmethylamino)ethanol(PO)₂]hexane,
1,6-[2-(N-dimethylamino)ethanol(PO)₄]hexane,
1,6-[2-(N,N-ethylmethylamino)ethanol(PO)₄]hexane,
1,6-[2-(N,N-butylmethylamino)ethanol(PO)₄]hexane,
1,6-[2-(N,N-methyloctylamino)ethanol(PO)₄]hexane,
1,6-[2-(N,N-dodecylmethylamino)ethanol(PO)₄]hexane,
1,8-[2-(N-dimethylamino)ethanol(PO)₂]octane,
1,8-[2-(N,N-butylmethylamino)ethanol(PO)₂]octane,
1,8-[2-(N,N-methyloctylamino)ethanol(PO)₂]octane,
1,8-[2-(N,N-dodecylmethylamino)ethanol(PO)₂]octane,
1,8-[2-(N-dimethylamino)ethanol(PO)₄]octane,
1,8-[2-(N,N-ethylmethylamino)ethanol(PO)₄]octane,
1,8-[2-(N,N-butylmethylamino)ethanol(PO)₄]octane,
1,8-[2-(N,N-methyloctylamino)ethanol(PO)₄]octane,
1,8-[2-(N,N-dodecylmethylamino)ethanol(PO)₄]octane, and a mixture thereof.

33. The surfactant system according to claim 14, wherein the anionic surfactant is selected from a group consisting of sodium lauryl sulfonate (SLS), sodium lauryl ether sulfonate (SLES), a linear alkyl benzene sulfonate (LAS), monoalkyl phosphate (MAP), acyl isethionate (SCI), an alkyl glyceryl ether sulfonate (AGES), acylglutamate, acyltaurate, a fatty acid metal salt, and a mixture thereof.

34. A detergent composition of solid, liquid, gel, or paste types comprising the surfactant system of claim 14.
